(19) United States
(12) Patent Application Publication
(10) Pub. No.: US 2008/0092114 A1
(43) Pub. Date: Apr. 17, 2008

(54) Computer Program, Program Executing Device, Program Generation Processing Program, Status Display Processing Program, And The Like

(75) Inventors: Yoshimichi Nakamura, Shizuoka (JP); Shoji Horiuchi, Shizuoka (JP)

Correspondence Address: YOUNG & THOMPSON, 745 SOUTH 23RD STREET, 2ND FLOOR, ARLINGTON, VA, 22202, US

(73) Assignees: Winz Coroporation, Numau-shi (JP); Mitsui & Co., LTD., Tokyo (JP)

(21) Appl. No.: 11/665,743

(22) PCT Filed: Oct. 14, 2005
(86) PCT No.: PCT/JP05/18962

§ 371 Date: Apr. 19, 2007

(30) Foreign Application Priority Data
Oct. 19, 2004 (JP) 2004-332430

(51) Int. Cl. G06F 9/44; G06F 11/28

(52) U.S. Cl. 717/107

(57) ABSTRACT

A high-reliability computer program, a program executing device, a program creating program for creating a high-reliability computer program, and a state displaying program are provided. The computer program is constituted of a set of capsule programs having the same structure and executed by a computer. Each capsule program allows a computer to function open data area elements where open data acquirable by another capsule program is set, open data acquiring elements for acquiring the open data set in the open data area elements in another capsule program, and main processing elements for executing a predetermined computation of the open data acquired by the open data acquiring elements and setting at least a part of the result of the computation as the open data in the open data area elements.

### BACKGROUND OF INVENTION

1. Field of Invention

The present invention relates to a computer program, a program executing device, a program generation processing program, a status display processing program and the like.

2. Related Art

A computer system which is embedded in the system to realize function is called an embedded system. The embedded system includes, for example, a microcontroller (MCU(Micro Controller Unit)) integrated with, for example, CPU and various peripheral equipment and a computer program called embedded software (hereinafter referred -to as “appropriate program” or “software”)and mounted on this microcontroller.

Among embedded software, software exclusively used for devices mounted on the microcontrollers of electronic control systems and power electronic systems is in the field which requires high reliability.

Along with recent high functionality of microcontrollers, systems such as control systems and power electronic systems have been increasingly controlled with embedded software. That means, since high integration and high performance have been improved and prices have been lowered in peripheral equipment, mounted on the microcontrollers, including CPU (Central Process Unit), A/D (Analog/Digital) converter, PWM (Pulse Width Modulation) generator, serial communication, RAM (Random Access Memory), and ROM (Read Only Memory), high speed responses which were conventionally realized by hardware become possible and can be replaced with microcontrollers.

An energy saving equipment for prevention from global warming is increasing, and developing tools for software specifying controlling of power devices and systems are sought. The present invention particularly relates to a computer program composed of a collection of capsule programs, a unit of software to enhance reliability of software for control systems and power electronic systems, a method developing thereof, and the like.

Under the circumstances that many embedded systems require high reliability and real time ability as power electronic systems do as well as that functions required for the embedded systems become complicated and highly sophisticated, it is often the case that RTOS (Real Time Operating System) is employed as an operating system for them.

RTOS is a multitask OS provided with mechanism for completing a process to satisfy the imposed time limit even on the occurrence of a plurality of processing requests (event or interrupt).

The computer program under the RTOS environment, a task as a unit of execution process is executed in multiply parallel based on a priority order set every task. Then each task exchanges information using functions such as synchronizing task (e.g. event flag, semaphore) and inter-task communication (e.g. message cue, mailbox) to realize functions as a whole by collaborating with other tasks.

With regard to creating source programs in embedded software, conventionally there has been a method in which users have computers execute editor programs and the like to edit source files. In recent years, there is proposed a method in which users add new program codes to models of source programs generated automatically to create source programs for the purpose of efficiency of program creation and error prevention due to manual input.

For example, Patent Document 1 describes a method for generating a class definition information file and models of a source file and a header file in which users add and compile program codes to and from a design model written according to UML (Unified Modeling Language) notation.

With regard to debug in embedded systems, employed is a method such as a debug system described in for example Patent Document 2. In Patent Document 2, a host computer is connected to the target device through ICE (In-Circuit Emulator) to set a break point, input debug commands such as monitoring and registering variable numbers, stop program execution, and display contents of the variable numbers.

Patent Document 1: Japanese Unexamined Patent Publication 2003-216428

Patent Document 2: Japanese Unexamined Patent Publication 2003-30003

### DISCLOSURE OF INVENTION

### Problems that the Invention is to Solve

Software of energy-related control requires extremely high reliability. Bugs of software stop energy flow or disable energy control. As a result, energy concentrates in the element conducting energy conversion and energy exceeding capacity flows into the element, thereby causing serious problems.

Bugs of software cause breakage of devices and an entire system. On the other hand, development of energy-saving equipment is globally proceeded to cope with global warming. Software designs for control systems and power electronic systems increase in quantity and diversity.

Thus, demand for embedded software for control systems and power electronic systems is further increased. To meet this demand, software engineers of control systems and power electronic systems are required to foster and software should be mutually understandable among engineers. Further, administrators desire to make software force of the company as technology assets in such way that the software created by engineers is kept in the form of company assets easily taken over by other engineers.

For this purpose, embedded type software and developing tools which are suitable in this field are especially needed.

However, it is difficult to design and verify all combinations compatibly in the configuration of the conventional computer program under RTOS environment where a plurality of tasks operate synchronously in parallel and a plurality of events occur.

Further, although optimal RTOS functions (e.g. event flag, semaphore, message cue) can be utilized by the mode of information exchange among tasks, every task has different configuration when utilizing a different function according to an information exchange mode, whereby design errors easily occur and maintenance performance is deteriorated.

In information exchange by task synchronization, inter-task communication and the like, tasks depend on the process with each other in such a way that a task suspends process until the other task releases a common source, requests the other task to process, or waits until information is sent from other task, whereby configuration has a complicated relation as a whole to easily cause design errors and makes it difficult to find which task has the cause when any problems occur.

Further, since programs are freely programmed when creating source program by editor program, created source programs having uneven configurations, therefore the program created by other users is difficult to understand. It is highly possible to create programs having tasks each have different configuration.

Meanwhile, as in the Patent Document 1, programming labor can be saved to some extent by automatically generating source programs. However, reliability of created programs is not concerned and programming for variable definition and information exchange is free hand for users.

Further, as in Patent Document 2, when stop execution of programs in the middle for displaying variable contents by debugging using ICE and he like, displayed variable contents are deviated from conditions of devices changing every second, whereby there becomes no meaning of displaying variable contents. Furthermore, there is possibility of breaking devices because devices operate without control of programs.

The present invention is made in view of the foregoing points and object of the invention is to provide highly reliable computer programs and program execution devices, and programs for processing program generation and programs for processing status display which can develop highly reliable computer programs.

### Means for Solving Problem

In order to solve the above-mentioned problem, according to a first aspect of the present invention, there is provided a program generation processing program executed by a second computer included in a program generating device for generating a computer program which is formed by an assembly of a plurality of capsule programs, the plurality of capsule programs having a same structure, and being executed by a first computer, the capsule programs respectively including:

an open data portion to cause the first computer function as an open data acquiring means for setting up the open data which are acquirable from another capsule program than the capsule program of this open data portion;

an open data acquiring portion to cause the first computer function as an open data acquiring means for acquiring the open data which are set up in the open data area means in the another capsule program; and

a main processing portion to cause the first computer function as a main processing means for executing a preset arithmetic processing to the open data, acquired with the open data acquiring means and setting up the open data area means with at least a part of results, which is obtained by the arithmetic processing as the open data, wherein the program generation processing program causes the second computer to function as a capsule code generating means, and

the capsule code generating means including:

a definition code generating means for generating program codes for defining the open data based on the definition information which is inputted by a user and is indicative of a content of definition of the open data set up in the open data area means;

an acquisition code generating means for generating program codes of the open data acquiring portion which acquires the open data selected by a user through the input means, out of the open data which are defined by the capsule program; and

a main processing code generating means for generating program codes of the main processing portion on the basis of the program code inputted by a user through the input means.

Accordingly, with use of the computer program which is generated by reading and executing the program generation processing program according to the present invention, the capsule program has a rule that data are publicly opened and the data are acquired with the open data acquiring means, and the main processing means executes the arithmetic processing based on the rule. Therefore, security of data is assured.

Further, each capsule program acquires open data by itself to perform arithmetic processing without depending on processes of the other capsule programs. Because programs have a same simplified configuration of opening at least a part of the result, design errors may hardly occur and reliability as a computer program increases.

By reading out and carry out the program generation processing program with the second computer, it becomes possible to easily generate the capsule program having the same structures for cause the computer function as an open data area means, an open data acquisition means, and a main processing means. Accordingly, a user is not motivated to have incentive of generating a program having a different structure. Therefore, it becomes possible to generate a computer program having a high reliability.

Further, the computer program includes an execution control program for controlling execution of the capsule programs with the first computer,

an execution unit in executing the plurality of capsule programs are set up with respect to a lapse of predetermined times within a repeated execution cycle,

each of the capsule programs is respectively allocated to at least one of the plurality of execution units on the basis of the repeated execution cycles respectively set up with respect to the capsule programs,

the execution control program executes the main processing portion of the capsule program, allocated to the execution unit thus corresponding at each lapse of the predetermined time and causes the first computer function as the execution control means for repeatedly executing the capsule programs, and

the program generation processing program further causes the second computer function as an execution control code generating means for generating a program code of the execution control program based on the execution cycle information which is inputted by a user through an inputting means and is indicative of the execution cycle with respect to each of the capsule programs.

Further, each of the capsule programs further includes a status providing portion for causing the first computer function as a status providing means for providing status of the arithmetic processing every predetermined period with the main processing means, and

a status provision code generating means for generating a program code of the status providing portion for providing information related to the open data based on the definition information, which is used for generating the program code, defining the open data.

Accordingly, in the computer program generated by reading out and executing the program generation processing program according to the present invention, since each of the capsule programs has functions for debugging to enable monitoring of status of arithmetic processing from outside by the main processing means, it becomes easy to debug the computer program especially in a system to which the computer program is installed. Therefore, reliability as the computer program is further improved.

Further, by reading out the program generation processing program with the second computer, it becomes possible to easily generate a program code for causing the computer function as the open data area means, the open data acquisition means, and the main processing means, and the program code for causing the computer function as the status providing means for externally providing the open data set up as a state of the arithmetic processing with the main processing means is automatically generated. Therefore, it is possible to drastically reduce labor of manually generating the program code for debugging capsule program by capsule program.

Further, the computer program further includes

a status provision selection executing program to cause the first computer function as a status provision selection executing means which acquires selection information indicative of selection of at least one of the capsule programs and executes processing in the status providing portion of the capsule program thus selected, wherein the execution control means executes the status provision selection executing program at each of the predetermined cycle, and the program generation processing program further causes the second computer function as a status provision selection executing code generating means for generating, program code of the status provision selection executing program.

Accordingly, it becomes possible to select the capsule program from an outside which provides state of the arithmetic processing with the main processing means by continuously reading out and executing the program generation processing program according to the present invention with the second computer. Therefore, debugging specialized inca predetermined capsule program becomes effective.

Further, the status providing means includes a status accumulating means for accumulating the statuses of the arithmetic processing of the main processing means every predetermined period, the statuses being executed by the status provision selection executing means; and a status en bloc providing means providing the accumulated statuses thus accumulated en bloc.

Therefore, statuses of arithmetic processing by the main processing means are once accumulated and later provided en bloc to outside. Therefore, frequency of providing is reduced, and status of arithmetic processing of the main processing means can be real-time monitored from outside without suspending execution of the computer program even in the system of strict condition which can not meet time requirement in the case of providing point to point at predetermined period.

Further, the status provision code generating means further generates a program code for the computer to function as the status providing means for providing information related to the open data informed by the designation information used for generating the program code for the computer to function as the acquiring means.

Therefore, since it is possible to create the capsule program capable of monitoring information related to open data acquired from not only open data defined in the capsule program but also the other capsule program, labor of generating a program code for manual debugging can be further reduced.

In order to solve the problem, according to another aspect of the present invention, there is provided a method for generating program codes in a program generating device for generating computer programs which is formed by an assembly of a plurality of capsule programs respectively having a same structure and executed by a computer, the computer program including:

an open data portion for causing the computer function as an open data area means where open data acquirable from another capsule program than the capsule program of this open data portion are set up;

an open data acquiring portion to cause the computer function as an open data acquiring means for acquiring the open data which are set up in the open data area means in the another capsule program; and

a main processing portion to cause the computer function as a main processing means for executing a preset arithmetic processing to the open data, acquired by the open data acquiring means and setting up the open data area means with at least a part of results acquired by the arithmetic processing as the open data,

the program code generating method in the program generating device for generating the computer program, formed by an assembly of the plurality of capsule programs having the structure thus formed, including:

a capsule code generating step of generating the program code with respect to each of the program codes;

the capsule code generating step including:

a definition code generating step of generating a program code for defining the open data based on definition information, which is input by a user through an input means and is indicative of definition content of the open data which are set up in the open data area means;

an acquisition code generating step of generating a program code of the open data acquiring means which acquires the open data selected by a user through the input means out of the open data thus defined by the another capsule program, and

a main process code generating step of generating a program code of the main processing portion which is inputted by the user through the input means.

In order to solve the above problem, according to another aspect of the present invention, there is provided a program generating device for executing the program generation processing program, wherein

the program generating device including the capsule code generating means.

In order to solve the above problem, according to another aspect of the present invention, there is provided a computer program which is generated with the program generation processing program according to any one of claims 1 to 6, and formed by an assembly of a plurality of capsule programs respectively having a same structure, wherein

each of the capsule programs is configured to include:

the open data portion;

the open data acquiring portion; and

the main processing portion.

### Effect of the Invention

According to the present invention, the capsule program has rules of data opening by open data and data acquirement by the open data acquiring means, and the main processing means executes arithmetic processing in compliance with this rule, thereby security of data is ensured.

Further, each capsule program acquires open data by it self to perform arithmetic processing without depending on processes of the other capsule programs, and resultantly programs have the same simplified configuration by opening at least partly, thereby design errors are prevented and reliability as a computer program improved.

Thus, according to the present invention, development of software of control systems and power electronic systems is dramatically improved in various phase covering education level, production development, and maintenance. With regard to reliability and quality improvement, effective are status providing means such as ACM (Analyzer Communication Method) described later and status display processing programs such as capsule analyzer described later. With regard to productivity of software, inheritance of code rule, maintenance and succession of skill after completion of software and fostering of new engineer, program generation processing programs such as capsule generator described later is effective.

### BRIEF DESCRIPTION OF DRAWINGS

FIG. 1 is a diagram showing one example of general configuration of a computer program P.

FIG. 2 is a diagram showing one example of structure of skeleton capsule 10.

FIG. 3 is a diagram showing one example of capsule 1 being called up.

FIG. 4 is a diagram showing one example of general configuration of development system S in this embodiment.

FIG. 5 is a diagram showing one example of a main screen 100 of the capsule generator.

FIG. 6 is a diagram showing one example of a visual controller window 107.

FIG. 7 is a diagram showing one example of a analyzer screen 180.

FIG. 8 is a diagram showing one example of scope winder 190.

FIG. 9 is a diagram showing one example of development using a target board B in this embodiment.

FIG. 10 is a diagram showing one example of development using a simulator in this embodiment.

FIG. 11 is a diagram showing an operating procedure in a new capsule creating box 102.

FIG. 12 is a diagram showing one example of header file (a) and source file (b) to a skeleton capsule.

FIG. 13 is a diagram showing one example of data-release variable setting window 120.

FIG. 14 is a diagram showing one example of program code of a generated ACM 14.

FIG. 15 (a) is a diagram showing one example of data acquisition variable setting window 130 and (b) is one example of modification.

FIG. 16 is a diagram showing one example of interior variable setting window 140.

FIG. 17 is a diagram showing one example of method function definition window 150.

FIG. 18 is a diagram showing one example of TSU embedment setting window 160.

FIG. 19 is a diagram showing one example of TSU2 source file.

FIG. 20 is a diagram showing one example of organization of capsule 1.

FIG. 21 is a flowchart showing one example of process of a microcontroller M in debugging

FIG. 22 is a flowchart showing one example of process of a microcontroller M and a development terminal T in debugging.

FIG. 23 is a diagram showing one example of general configuration of development system S1 related to this embodiment.

FIG. 24 is a diagram showing one example of capsule configuration of relay control program P1 related to this embodiment.

FIG. 25 is a diagram showing one example of result of a graph displaying public data of each capsule. (a) output voltage (b) noise-removed output voltage, (c) rectified voltage, (d) effective voltage, and (d) alarm value.

### BRIEF DESCRIPTION OF DRAWINGS

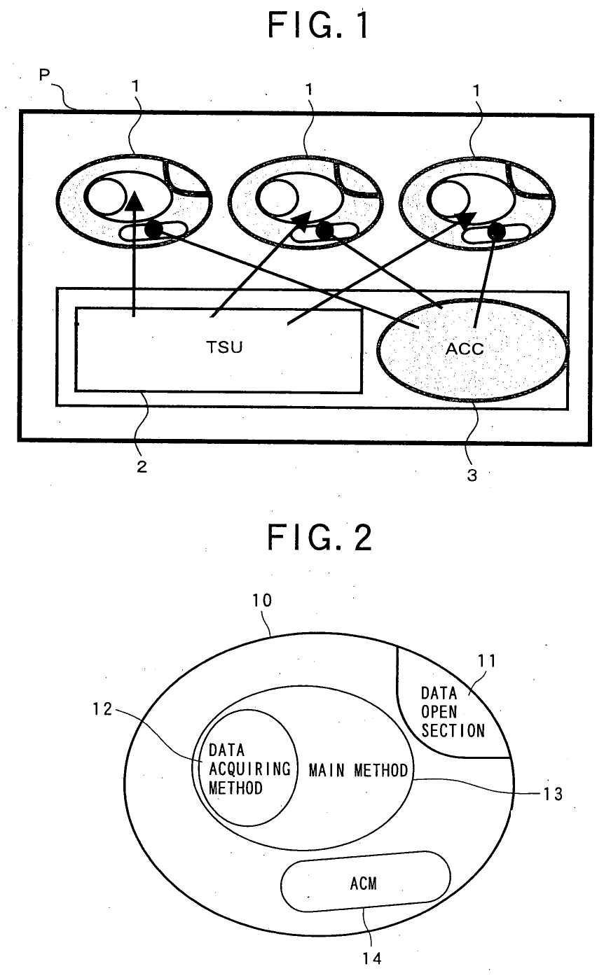

FIG. 1 is a diagram showing one example of general configuration of a computer program P.

FIG. 2 is a diagram showing one example of structure of skeleton capsule 10.

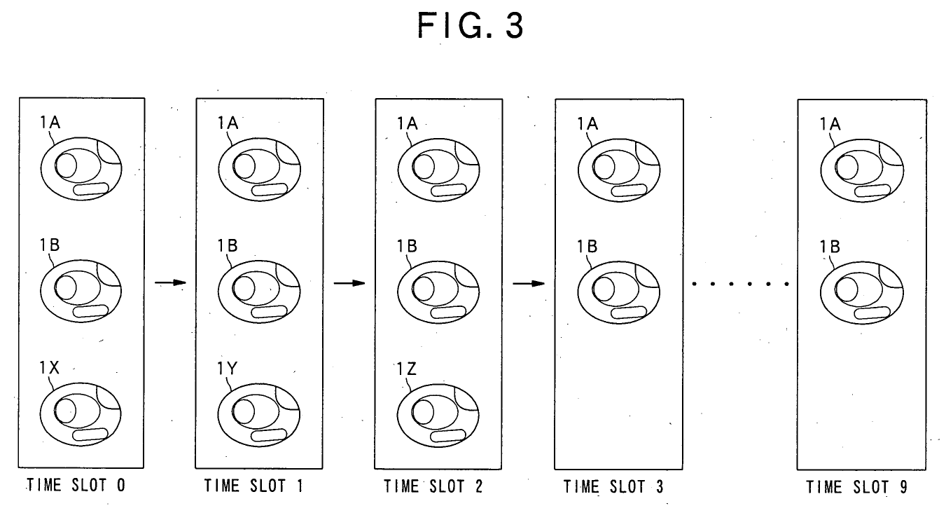

FIG. 3 is a diagram showing one example of capsule 1 being called up.

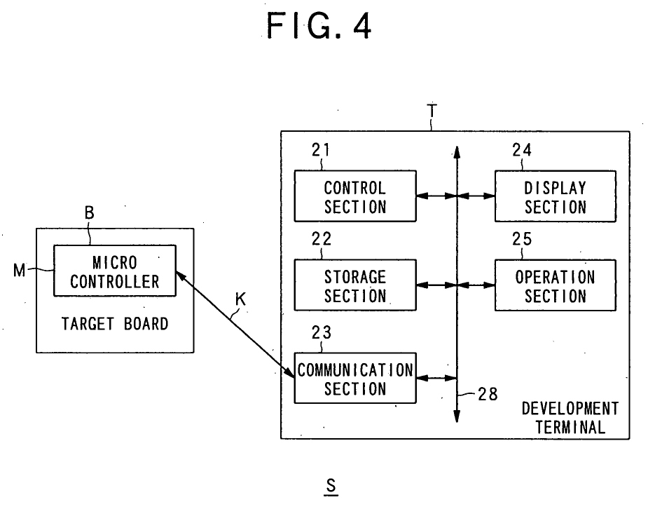

FIG. 4 is a diagram showing one example of general configuration of development system S in this embodiment.

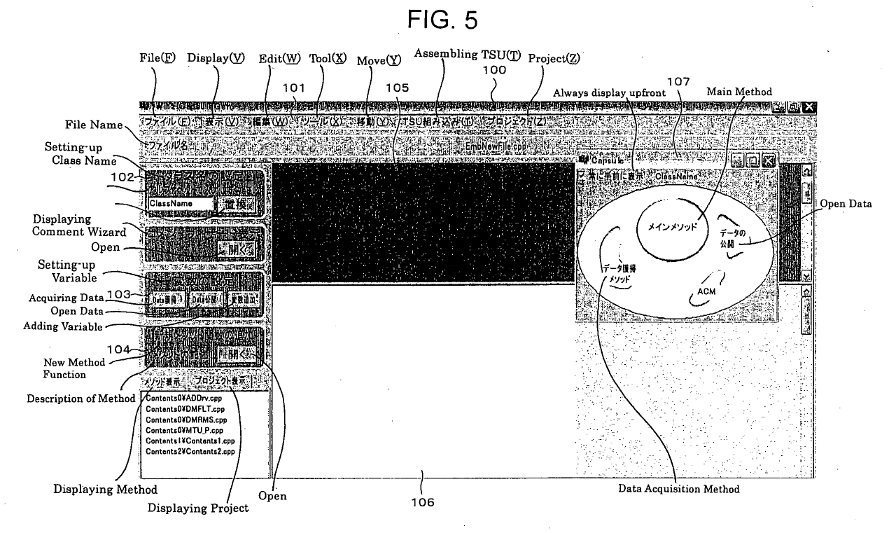

FIG. 5 is a diagram showing one example of a main screen 100 of the capsule generator.

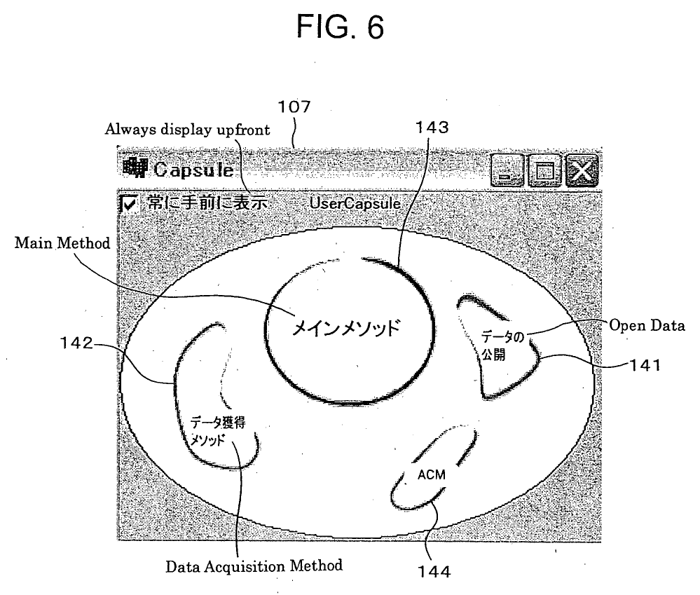

FIG. 6 is a diagram showing one example of a visual controller window 107.

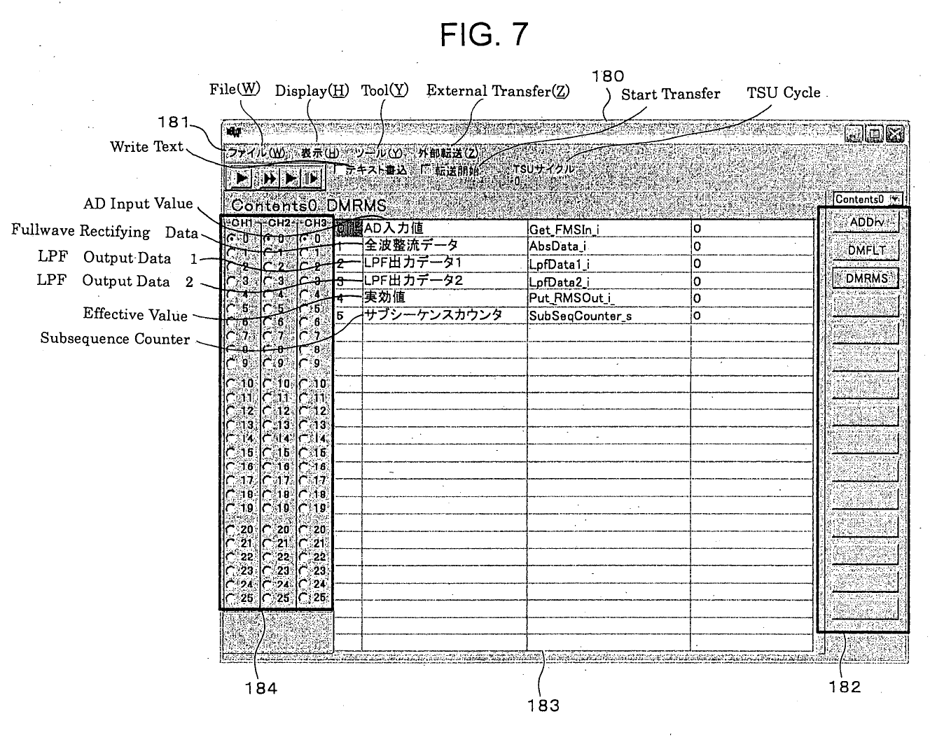

FIG. 7 is a diagram showing one example of a analyzer screen 180.

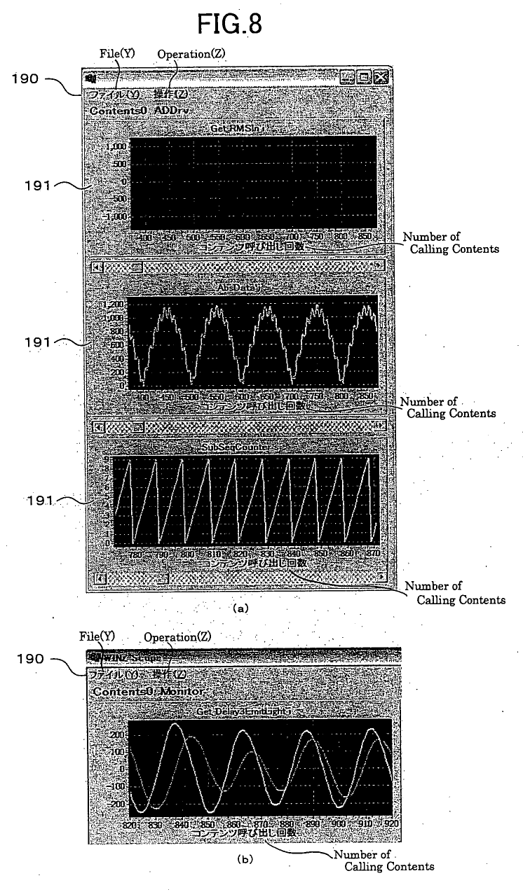

FIG. 8 is a diagram showing one example of scope winder 190.

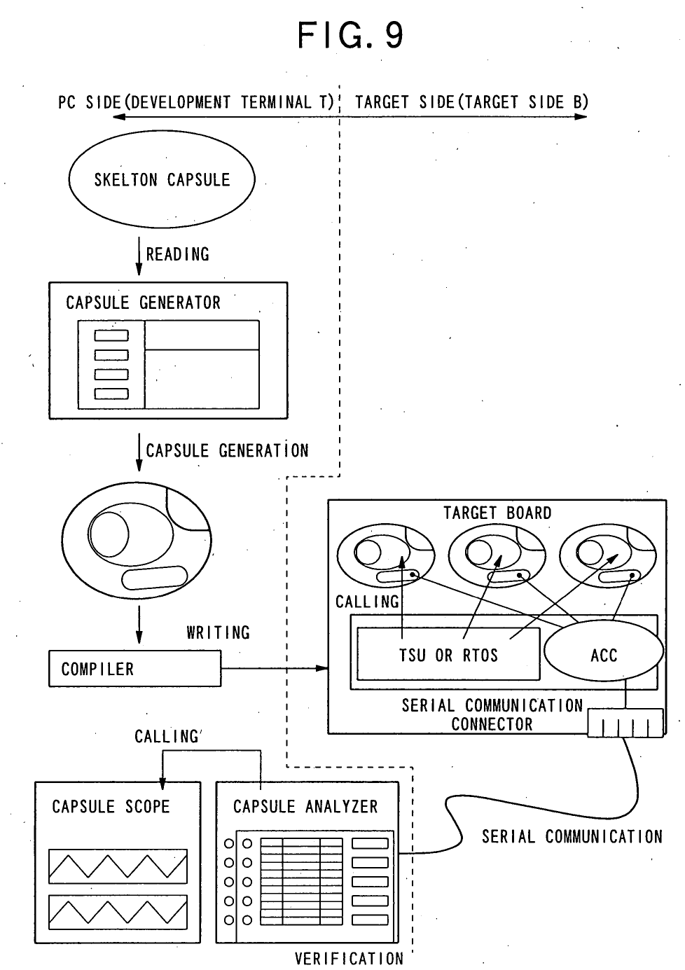

FIG. 9 is a diagram showing one example of development using a target board B in this embodiment.

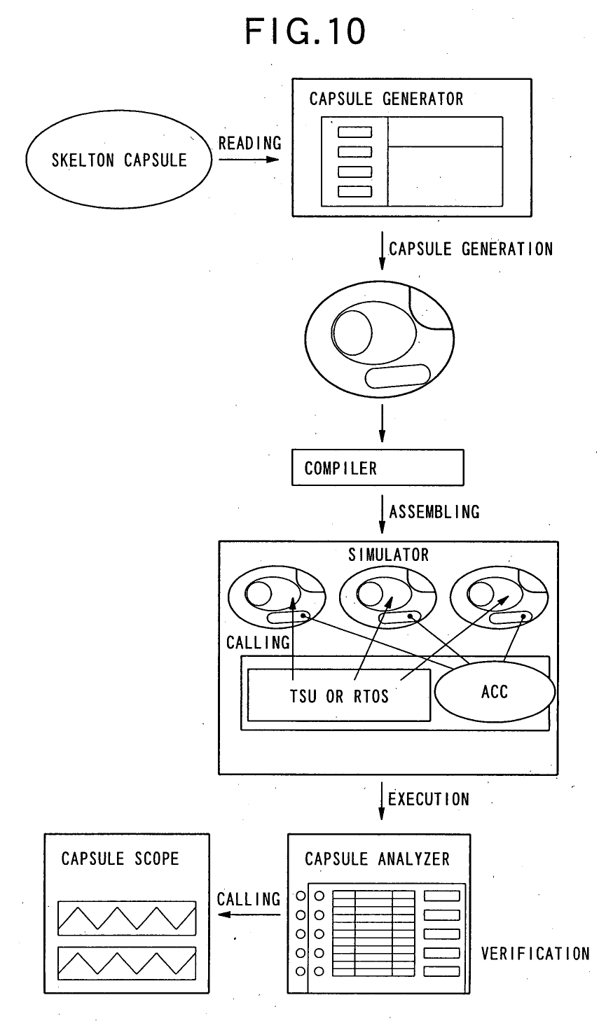

FIG. 10 is a diagram showing one example of development using a simulator in this embodiment.

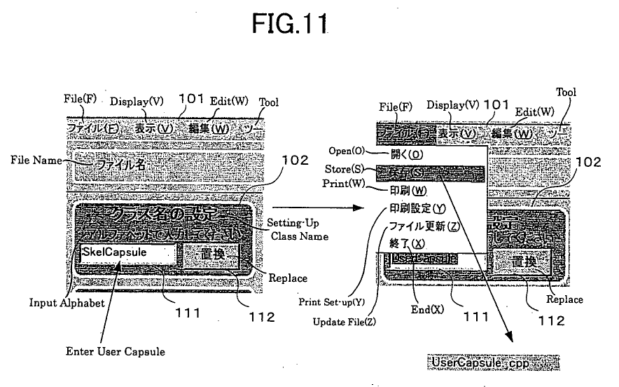

FIG. 11 is a diagram showing an operating procedure in a new capsule creating box 102.

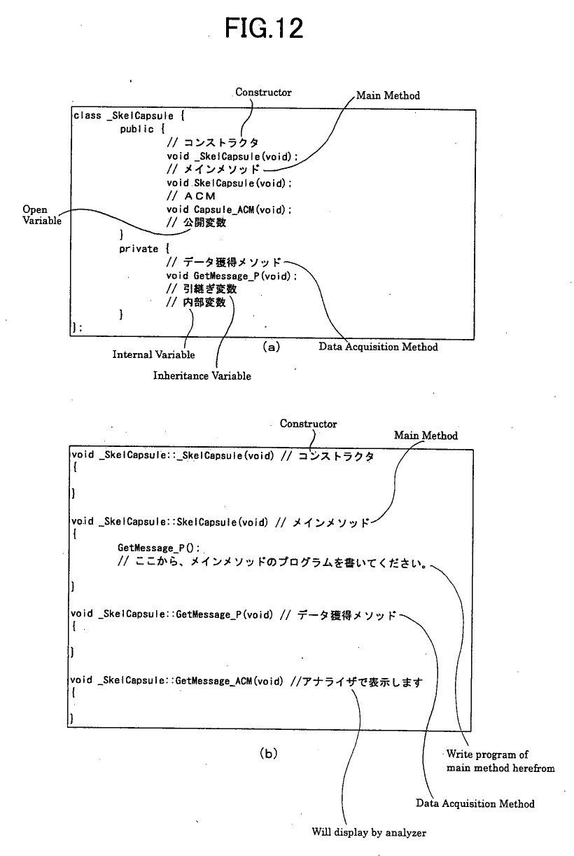

FIG. 12 is a diagram showing one example of header file (a) and source file (b) to a skeleton capsule.

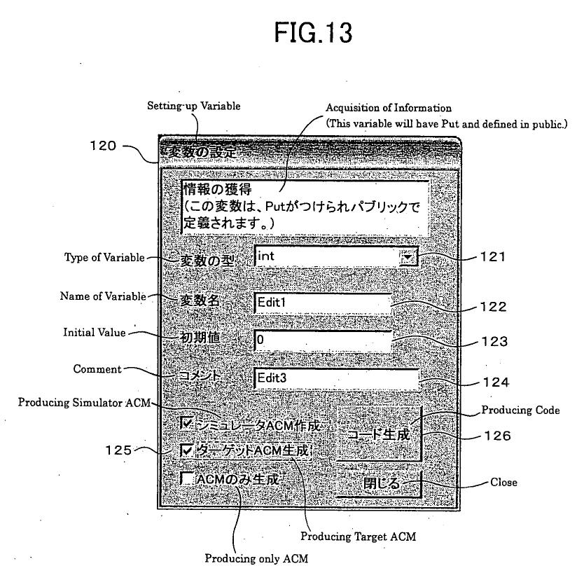

FIG. 13 is a diagram showing one example of data-release variable setting window 120.

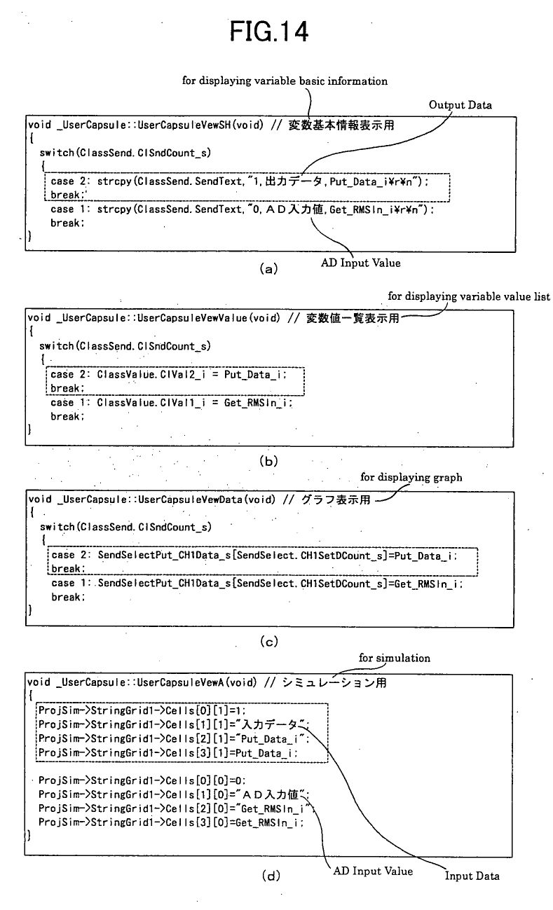

FIG. 14 is a diagram showing one example of program code of a generated ACM 14.

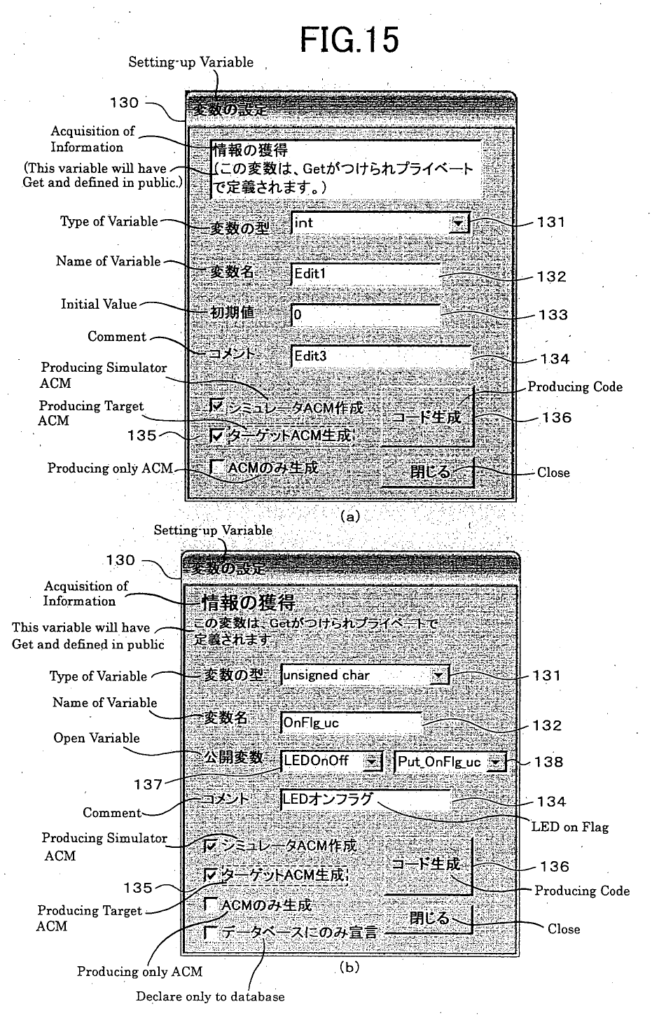

FIG. 15 (a) is a diagram showing one example of data acquisition variable setting window 130 and (b) is one example of modification.

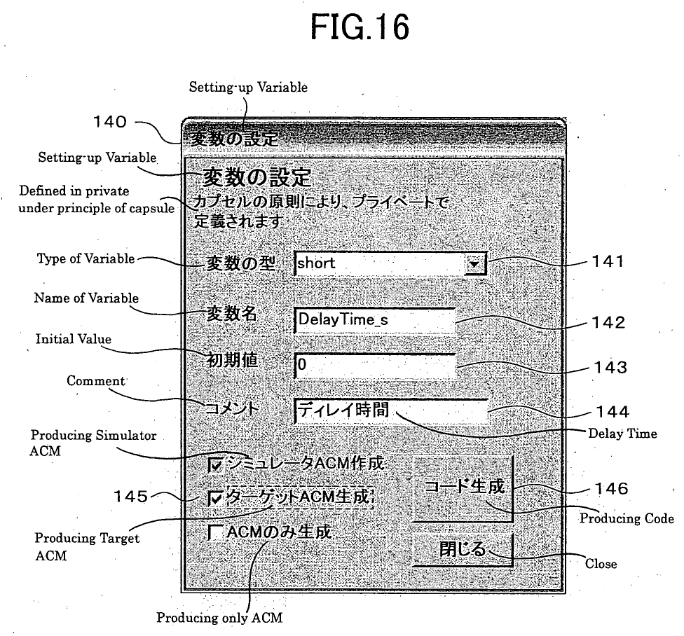

FIG. 16 is a diagram showing one example of interior variable setting window 140.

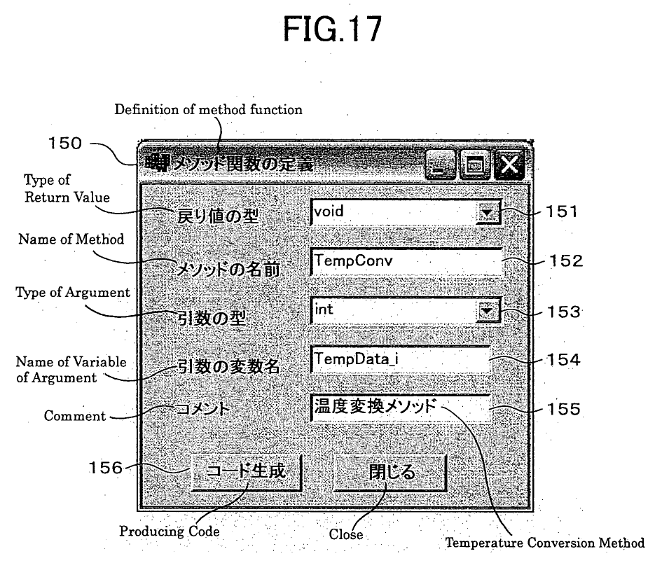

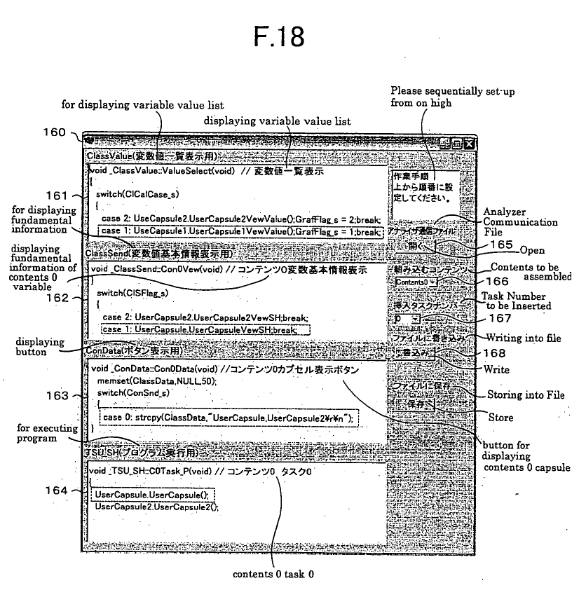

FIG. 17 is a diagram showing one example of method function definition window 150.

FIG. 18 is a diagram showing one example of TSU embedment setting window 160.

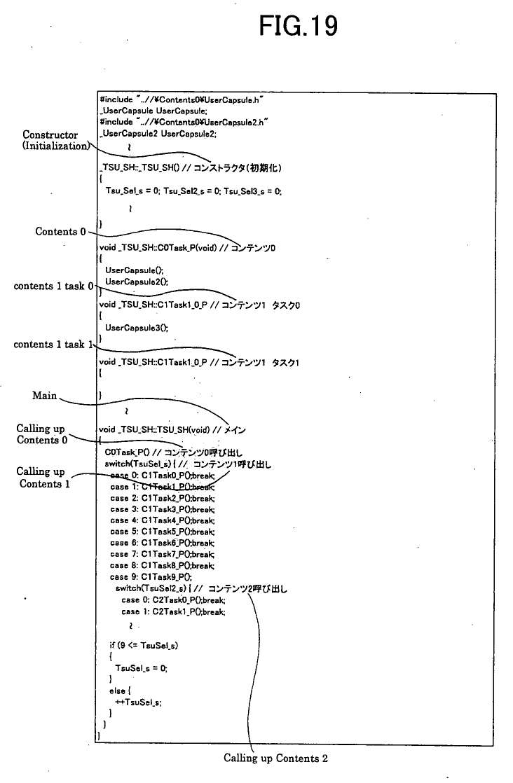

FIG. 19 is a diagram showing one example of TSU2 source file.

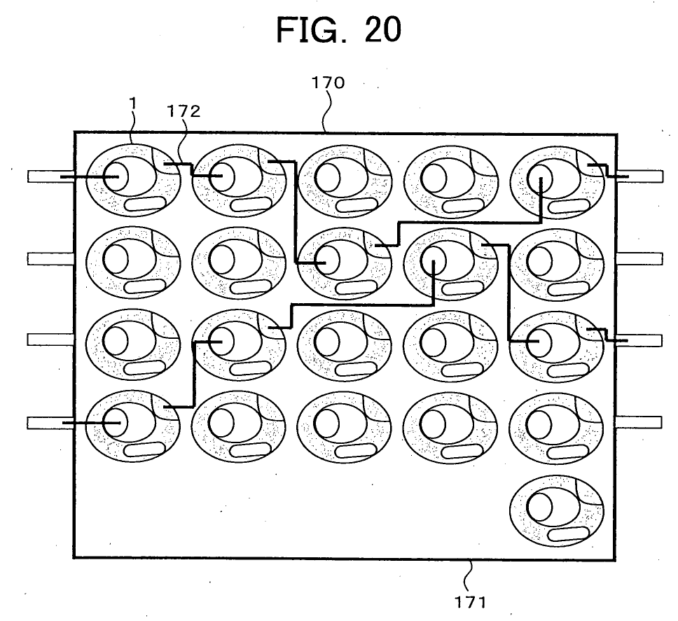

FIG. 20 is a diagram showing one example of organization of capsule 1.

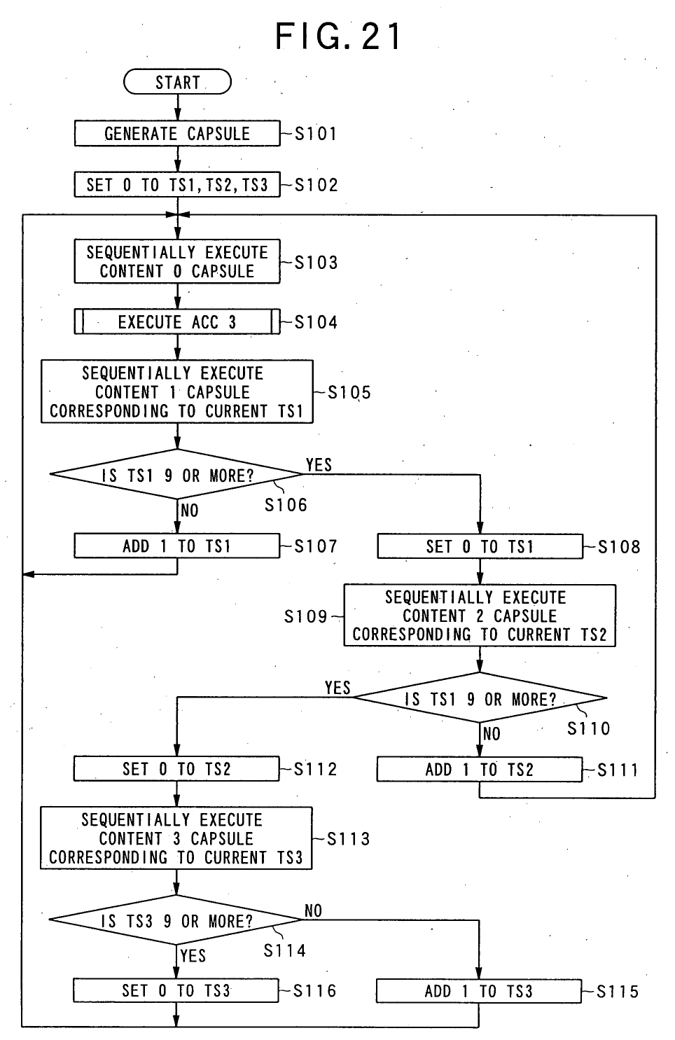

FIG. 21 is a flowchart showing one example of process of a microcontroller M in debugging

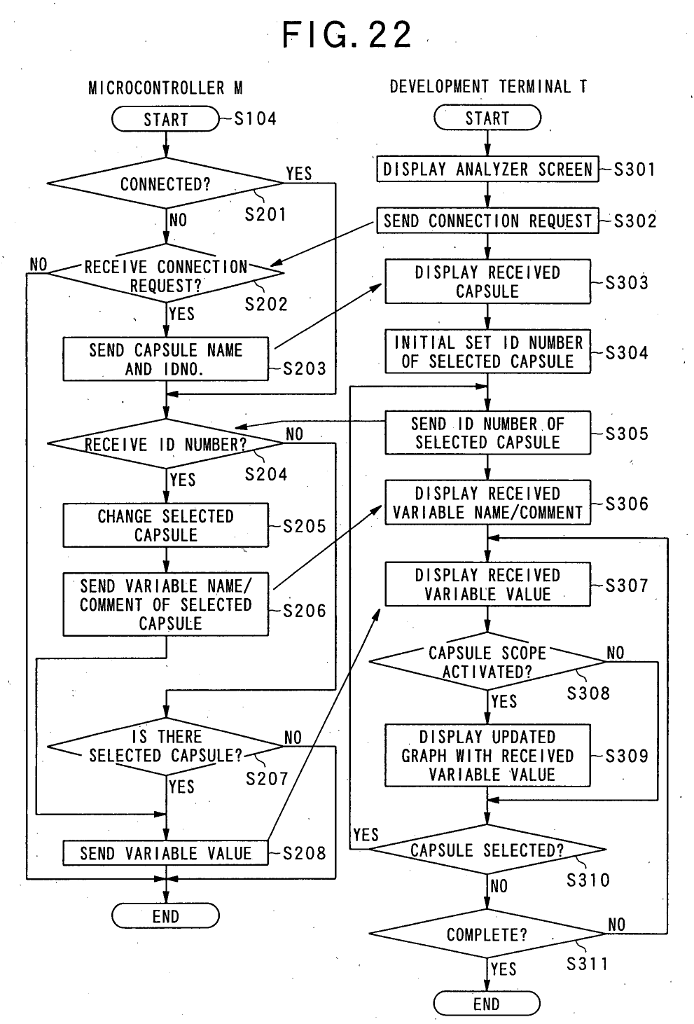

FIG. 22 is a flowchart showing one example of process of a microcontroller M and a development terminal T in debugging.

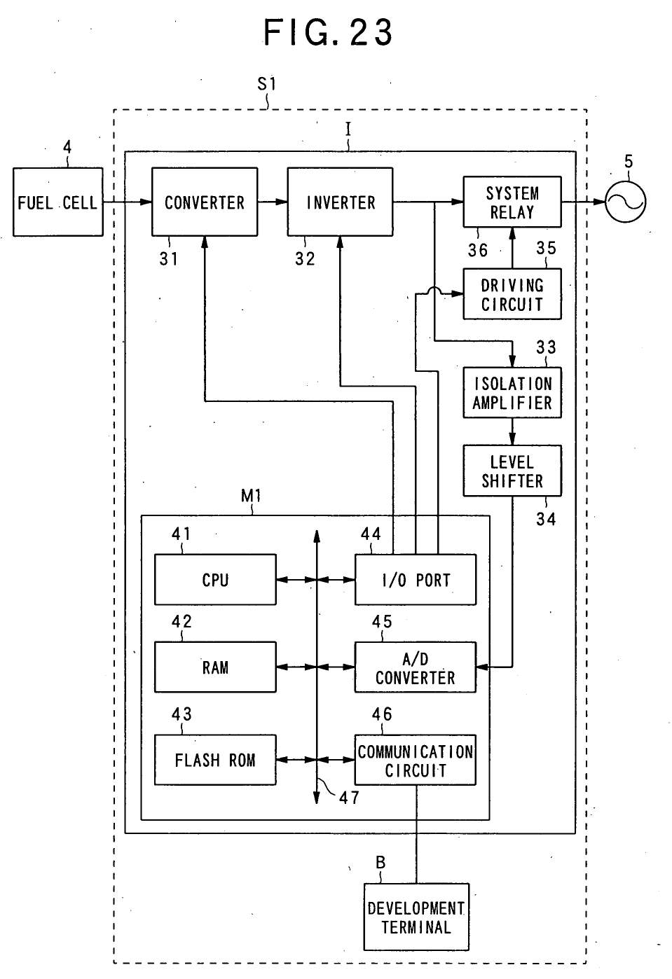

FIG. 23 is a diagram showing one example of general configuration of development system S1 related to this embodiment.

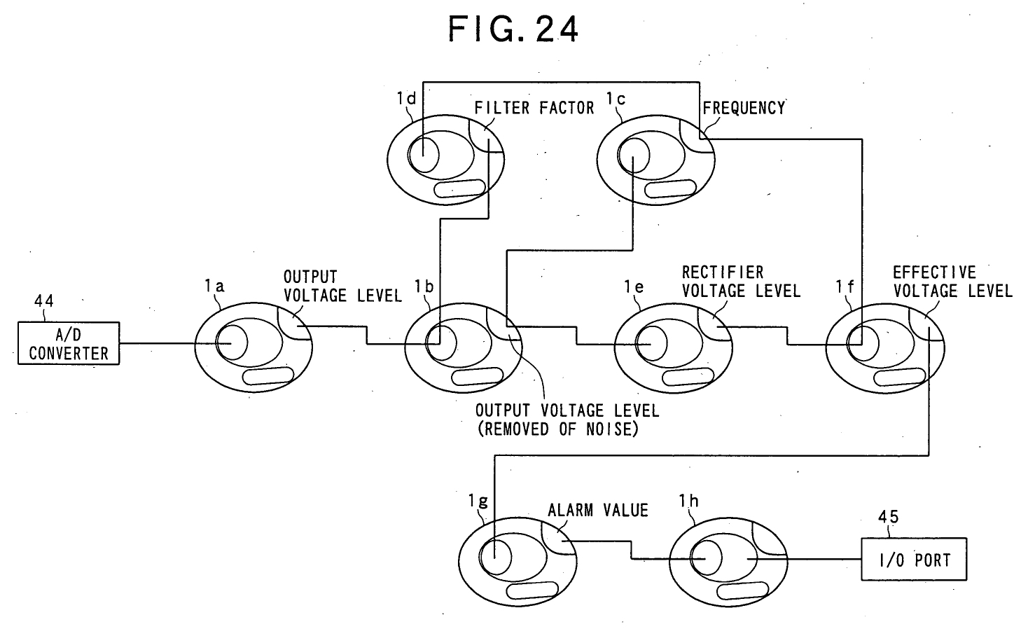

FIG. 24 is a diagram showing one example of capsule configuration of relay control program P1 related to this embodiment.

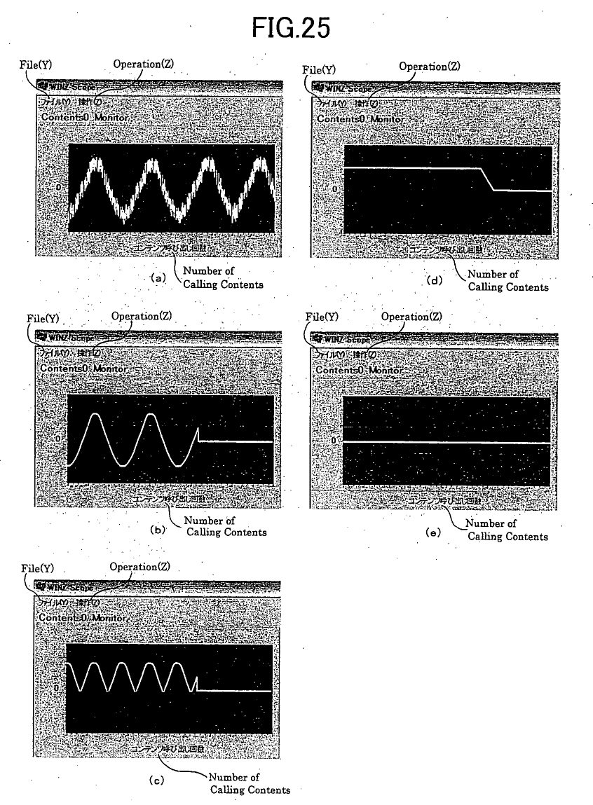

FIG. 25 is a diagram showing one example of result of a graph displaying public data of each capsule. (a) output voltage (b) noise-removed output voltage, (c) rectified voltage, (d) effective voltage, and (d) alarm value.

### DESCRIPTION OF NUMERAL REFERENCE

1, 1A, 1B, 1X, 1Y, 1Z, 1a, 1b, 1c, 1d, 1e, 1f, 1g, 1h

Capsule

TSU

ACC

Fuel cell

System

Skeleton capsule

Data open section

Data acquiring method

Main method

ACM

Control section

Storage section

Communication section

Display section

Operation section

Converter

Inverter

Isolation amplifier

Level shifter

Driving circuit

System relay

CPU

RAM

Flash ROM

I/O port

A/D converter

Communication circuit

P Computer program

S, S1 Development system

B Target board

M, M1 Microcontroller

T Development terminal

K Serial communication cable

I System interconnection inverter

### The Best Mode for Carrying Out the Claimed Invention

Hereinafter, preferred embodiments of the present invention will be described with reference to drawings. Embodiments described below are for the present invention applied to development systems for embedded computer programs using C++ as a development program language.

[1. Basic Configuration of Computer Program P]

First, a computer program P related to the present invention is described.

The computer program P is generated by the capsule generator as a program generation process program mentioned later.

FIG. 1 is a diagram showing one example for general configuration of the computer program P.

As shown in FIG. 1, the computer program P includes a plurality of capsule programs 1 (hereinafter simply referred to as “capsule”), TSU 2(Time Sharing Unit) for making a computer function as an execution control means, and ACC (Analyzer Communication Capsule) for making a computer function as a status provision selection executing means.

The capsule 1 is a program which has a code for realizing a specific function required by a target device and called out by TSU 2 conducing execution control.

ACC 3 is a special capsule to be an interface between a capsule 1 and a capsule analyzer mentioned below so that a status of computation process can be monitored from outside.

[1.1 Configuration and Function of Capsule 1]

A unit of program having a simple structure is called capsule and each capsule 1 has the same structure.

Each capsule 1 can perform different function but all structures are basically same. For this reason, a skeleton capsule 10 is provided.

FIG. 2 is one example of structure of the skeleton capsule 10.

As shown in FIG. 2, the structure of the skeleton 10 has a data open section 11 for making a computer function as open data area means, a data acquiring method 12 for making a computer function as open data acquisition means, a main method 13 for making a computer function as a main processing means, and ACM 14 (Analyzer Communication Method) to activate a computer to function as a status providing means.

The skeleton capsule 10 is capsulated by an object-oriented class concept and prepared as a source file having a model of the capsule 1 (e.g. processing instruction is described: extension.cc) and a header file (e.g. class definition, external reference declaration etc. is described: extension.h).

The skeleton capsule 10 is customized as a base with a capsule generator by users to create the capsule 1.

Therefore, the capsule is also has a structure comprising a data open section 11, an acquiring method 12, a main method 13, and ACM 14 because a new capsule 1 is generated by reading this skeleton capsule 10.

For the skeleton capsule 10 which is to be base of all capsules 1, it is desired that previous inspection is completed and reliability is secured.

[1.1.1 Data open section 11]

A data open section 11 is an area in which open data accessible from other capsules 1 is set up and a result obtained by arithmetic processing by the main method described later is set.

This area is secured in memory such as RAM during execution time of the computer program P.

A result of the arithmetic processing of capsule 1 is open for use of the other capsule 1, and the data are declared as a global variable (public variable) by a capsule generator function for opening the result as open data to other capsules. A variable set with open data is called an open variable.

Other data except for the open data are hidden from other capsules 1 by the capsule generator function. For this reason security of data except for the open data is secured.

[1.1.2 Data Acquiring method 12]

A data acquiring method 12 is a method prepared to clarify which information (open data) of capsule 1 is referred by the currently active capsule 1. This method is a function which is called by function call, from the main method 13 described later and acquires and collects data opened in other capsules 1 (that is, acquires and processes open data set in data open section 11 of other capsules 1).

Specifically, it performs of process of setting open data of other capsule 1 to an internal variable or takeover variable of a capsule 1. Thus security of open data is ensured because open data of other capsules 1 are not directly operated.

Therefore, the data acquiring method 12 makes a computer function as an open data acquiring means for acquiring open data set in the data open area in other capsules 1.

The data acquiring method 12 is hidden from other capsules 1 by declaring as a private variable with the capsule generator function.

[1.1.3 Main method 13]

The main method 13 is a function which is called when TSU 2 or RTOS executes capsule 1. The main method is preliminarily embedded. Executing a capsule corresponds to calling out the main method 13.

The main method 13 is a function which makes a computer function as a main processing means for performing a arithmetic processing (arithmetic processing includes a setting process of assignment from variable to variable as well as a calculation process of addition, subtraction, multiplication, and division) preset against open data acquired by the data acquiring method 12 and for at least partially setting the result obtained by the arithmetic processing as open data in the data open section 11.

TSU 2 or RTOS (in the case of operating the computer program P under RTOS environment) activates this main method 13 in executing capsule 1.

A function (i.e. member function of the same class) inside the same capsule 1 directly or indirectly called out by function call from the main method 13 also makes a computer function as a main processing means together with the main method 13.

[1.1.4 ACM 14]

ACM 14 is a method of performing access from outside for verifying a capsule 1 while activating a capsule 1, and being declared as a global function (public function) to exchange information between a capsule internal variable and a capsule analyzer.

The ACM 14 has a function to observe variable contents of the capsule 1 by an exterior capsule analyzer described later, communicates with the capsule analyzer and real-time transfers status of variable and others of the capsule 1 to the capsule analyzer. Therefore, users can confirm and track contents displayed by the capsule analyzer and correct defect portions.

Specifically, the ACM 14 includes a variable basic information displaying method, a variable value list displaying method, and a graph displaying method.

The variable basic information displaying method is a method for displaying variable name and comment as information of data having a selected capsule 1 in the capsule analyzer and transferring the information.

According to the abovementioned variable basic information displaying method, variable information of capsule 1 can be displayed even if the capsule analyzer side has no information about capsule 1 variable.

The variable value list displaying method is executed every pre period (e.g. 10 m sec.) by calling out a function from ACC3 and data content such as open variable, take-over variable, and other interior variables (these are intermediate progress or results showing status of arithmetic processing in the main method 13) are transferred to the capsule analyzer. The content of transferred data is displayed as a list of variable values.

Therefore, the ACM 14 causes a computer to function as a state providing means for providing arithmetic processing status of the main method 13 at predetermined period. The call period of variable value list displaying method may be longer than call period of the capsule 1. When a variable value is transferred in period of 100.sec. and displayed by the capsule analyzer with call period of the capsule 1 of, for example , 100.sec., human eyesight can not catch up with it.

The graph displaying method is a function to store data contents every time the capsule 1 is called out, and these contents are transferred to the capsule analyzer and can be graphed by a capsule scope. Users analyze the graphed data and find computation errors of the capsule 1 and defect occurrences.

In a graph display, unlike the above mentioned display of the variable value list, it is desired to reflect the data content every call of the capsule 1 on a graph in order to grasp data content changes in detail. However, when data contents are transferred in the same period as the call period of the capsule 1, the process of the main method 13 is compressed by this transferring process and there is a possibility that the real time process can not be realized. Therefore, in the graph displaying method, data contents are accumulated every call and accumulated data are en bloc transferred to the capsule analyzer at a rate of e.g. once out of 500 times of calls, thereby CPU occupation rate of the ACM 14 is decreased.

Therefore, ACM 14 makes a computer function as an accumulating means for accumulating arithmetic processing statuses (data contents) of the main method 13 every predetermined period executed by the ACC3 and as a status en bloc providing means for en bloc providing statuses of accumulated arithmetic processing. If real-times processing is ensured, data contents may be sequentially transferred to the capsule analyzer without accumulating data contents

In the capsule generator, when users register variables of capsules, codes for the variables for transferring variable existence (variable name, comment, variable value etc.) to the capsule analyzer are generated in the ACM method 14. This ACM code generating function at the time of variable registration can cut design codes for debug.

The ACM 14 may be deleted after completion of debug.

[1.2 TSU 2]

TSU 2 is a program corresponding to a section conducting execution control of tasks and embeds a main method 13 of a capsule 1 to provide a method for calling at predetermined intervals (e.g. 100.sec.). That is, arithmetic processing is sequentially repeated every predetermined period preset per capsule 1 by the main method 13 each capsule 1.

FIG. 3 is a diagram showing one example of capsule 1 called up in TSU 2.

A time slot shown in FIG. 3 is a unit of repeat call period set at, for example, 1.sec.

In TSU 2, capsules 1A, 1B and 1X are sequentially called out in a time slot 0 and capsules 1A, 1B, and 1Y are sequentially called out in the next time slot 1. Then in a time slot 2, capsules 1A, 1B, and 1Z are sequentially called out. Then only capsules 1A and 1B are called out in time slots 3 to 9.

With repeat calling with regard to time slots 1 to 10, capsules 1A and 1B are called out in period of, for example, 100.sec. and capsules 1X, 1Y and 1Z are called up in period of 1 msec.

The period calling capsule may be selected by users based on process urgency, time restriction and other conditions per capsule.

RTOS executes in parallel while switching tasks in preset priority order (i.e. execution control shifts to other task during operation of arithmetic processing a given task) While, TSU 2 sequentially executes each main method 13 in a round-robin method (i.e. the other main method 13 is not executed by completion of arithmetic processing a given main method 13). Thereby a plurality of main methods 13 are executed in parallel.

Thus comparing with RTOS, a capsule 1 is executed by an extremely simplified execution rule to perform parallel processes by a computer, thereby design, verification and others becomes easy.

Here, to execute an appropriate real-time processing by each capsule 1 to be embedded in TSU 2, each capsule is required to design in such that the sum of capsule 1 execution time every period falls within the period.

For example, in the period 1 in FIG. 3, the sum of execution time of capsules 1A, 1B and 1X falls within 100.second.

TSU 2 also makes ACC3 execute with function call in predetermined period (e.g. 1.sec.). Therefore, data of capsule 1 are real-time transferred to the capsule analyzer with ACM 14 through a selection execution processing of ACC3 and ACM14 described later.

Although the capsule 1 is assumed to be embedded in TSU 2 and constantly operate at predetermined intervals, basically, it is not limited to this and it may be embedded in RTOS. In this case, a computer program P consists of a plurality of capsule 1, a kernel of RTOS, and ACC 3, and a main method 13 of each capsule 1 is activated from the kernel.

[1.3 ACC 3]

ACC 3 is a special capsule to be an interface between a capsule analyzer and ACM 14.

When ACC 3 establishes communications with the capsule analyzer, first it transfers capsule names, identification umbers etc. of all capsules held by the computer program P to the capsule analyzer. Therefore, users can select the capsule to be desired to monitor through the capsule analyzer.

When ACC 3 receives identification number (one example of selection information related to the present invention) indicating selection request of the capsule 1 from the capsule analyzer, ACC 3 operates as a selector for calling ACM 14 of the capsule 1 indicated by the identification number, thereby variable information (variable name, comment, variable value etc.) of capsule 1 can be carried to the capsule analyzer with ACM 14.

According to this, ACC 3 makes a computer function as a status information provision selecting execution means for acquiring an identification number indicating at least a single capsule 1 and for executing the process with ACM 14 in the selected capsule every predetermined period.

The capsule 1 having the above mentioned structure has a data open section 11 and a data acquiring method 12 to have a rule of information exchange. That means, each capsule 1 can acquire only open data out of data held by the other capsule, and the open data are not changed but only acquired by the other capsules, whereby security of data can be ensured and independency of each capsule 1 is also ensured to improve reliability as a whole.

In the computer program P, each capsule 1 is sequentially called in a round robin method from TSU 2 to acquire data opened in the other capsule 1 with the data acquiring method 12. Based on it, a computer operates to perform arithmetic processing with a main method 13 based on it, and to set a result obtained from the arithmetic processing as open data according to necessity in the data open section 11 capable of acquiring from other capsules, thereby each capsule 1 autonomously operates.

Thus the capsules 1 exchange information with each other and independently operating in parallel, so that arithmetic processing of the capsules 1 interacts with each other and function of the computer program configured by collection of these capsules 1 is realized.

Therefore, there is basically no need to program to make a given capsule 1 activate the other capsule 1 with inter-task communication and others and obtain a result of the processing (i.e. a process of the capsule 1 directly depends on a process of the other capsule 1).

With regard to configuration of the capsule 1, the capsule 1 in the side of acquiring open data dose not directly set the open data to the takeover variable with the data acquiring method 12, but service variable providing the contents of the open data may be prepared in the capsule 1 in the side of defining the open data and the service variable is called with the data acquiring method 12 in the capsule in the acquiring side. In this configuration, the open data can be declared as private variable.

[2. Configuration of Development System S]

Next, configuration and function of a development system S related to the present invention will be described.

FIG. 4 is a diagram showing one example of general configuration of the development system S related to the present invention.

As shown in FIG. 4, the development system S includes a target board B as a program executing device and a development terminal T as a program generating device and a status displaying device, and these are connected with a serial communication cable K.

The target board B and the development terminal T are capable of mutually communicating with each other with serial communication (e.g. RS-232C (Recommended Standard 232C), Ethernet (Registered Trademark)) through the serial communication cable K.

[2.1 Configuration of Target Board B]

The target board B installs a computer program P and mounts a microcontroller M as a computer for executing the computer program P, a serial communication connecter for connecting the serial communication cable K, and others.

The microcontroller M includes CPU, RAM for temporarily storing data and the like, flash ROM for storing various programs (e.g. RTOS, computer program P etc.), a communication circuit for controlling condition of communication with the development terminal T through the serial communication cable K connected with the communication connector (e.g. RS-232C controller, Ethernet (Registered Trademark) controller etc.), an A/D converter for converting analog signals supplied from outside into digital signals, and an I/O port for controlling peripheral circuits on the target board B.

In the microcontroller M, CPU reads various programs stored in ROM to integrally control the target board B and is caused to function as a program executing device related to the present invention.

[2.2 Configuration of Development Terminal T]

The development terminal T is a terminal for generating the computer program P and debugging the computer program P embedded in the target board B. For example, a personal computer and a workstation etc. are applicable.

The development terminal T includes a control section 21 comprising CPU, RAM, and ROM, a memory section 22 (e.g. hard disk, nonvolatile memory etc.) for storing various programs (e.g. operating system, capsule works (capsule generator, capsule analyzer, capsule scope), compiler etc.) and data (e.g. source file for capsule 1, source file for skeleton cell 10 etc.), a communication section 23 (e.g. RS-232C (Recommended Standard 232C) controller, Ethernet (Registered Trademark) controller etc.) for controlling communication condition with the target board through the serial communication cable K, a display section 24 (e.g. display etc.) for displaying information such as characters, images etc.), and operation section 25 (e.g. keyboard, mouse etc.) as a operation information inputting means for receiving operation instructions for users. Then those are mutually connected with each other through bus 28.

In the control section 21, CPU reads various programs stored in ROM or the memory section to integrally control the development terminal T, and is caused to function as a code generating means, an acquiring code generating means, a main process code generating means, a status provision instruction code generating means, an execution controlling code generating means, a status provision instructing means, and a status displaying means.

[2.3 Capsule Works]

The capsule works is software for developing the computer program P by execution of the development terminal T and includes a capsule generator as a program generating program and a capsule cope and a capsule analyzer as a status displaying program.

[2.3.1 Capsule Generator]

The capsule generator is a software developing tool designed specifically for generating a reliable and high-quality capsule 1.

The capsule generator has a function to navigate engineers and a function to generate codes, particularly a function to automatically generate ACM codes for verification.

To realize software of control systems and power electronic systems is to create a necessary capsule 1, collect and organize capsules 1, and perform a task specified for a device by real-time multitasking while exchanging information between capsule 1 and capsule 1. Productivity of software, code understanding of software, and fosterage of engineers are greatly improved by many capsules 1 generated from a simple structure skeleton capsule 10 and the capsule generator.

FIG. 5 is a diagram showing one example of a main screen 100 of the capsule generator. FIG. 6 is a diagram showing one example of a visual controller window 107.

When the capsule generator is activated, the main screen 100 as shown in FIG. 4 is displayed in the display section 24.

The main screen 100 includes a menu bar 101, a new capsule creating box 102, a variable setting box 103, a new method adding box 104, a header display area 105 for displaying contents of a header file (extension .h) of selected capsule 1, a source edition area 106 for displaying contents of a source file (extension .cpp) of a method of selected capsule 1 and users editing program codes, and the visual controller window 107.

Users operates the menu bar 101 to execute the control section 211 of the development terminal T, for example, to store capsules, read, embed capsules to TSU2, add capsule project, and compile.

In order to develop capsules, the verified skeleton capsule 10 is read first, users input a new capsule name in the new capsule creating box 102, and thereby a source file and a header file of a capsule 1 having a name of the input capsule are generated by the control section 21 from the source file and the header file of the skeleton capsule 10 (this is also called a birth of new capsule).

Then users input a program code so that the program code is added in the main method 13 of the source file generated by the control section 21.

Further, in the variable setting box 103, users select any button to display any one of a data opening variable setting windows, a data acquiring variable setting window, or an internal variable setting window corresponding to respective buttons. Then users input definition information (e.g. variable name, variable type, comment, initial value) and specification information (e.g. capsule name, variable name) make the control section 21 to generate program codes for defining open data, acquiring open data, defining internal data, etc., and generate ACM codes for respective data.

Further, in the new method adding box 104, users select a button to display the function definition menu, and users input a function name, a function type, etc. to make the control section 21 add new function program codes for respective data in the source file and the header file.

Then, users input a program code to make the control section 21 add the program code in a new method of the source file.

As shown in FIG. 6, the visual controller window 107 is provided with a data opining button 141, a data acquiring method button 142, a main method button 143, an ACM button 144, etc. and can perform editing operation by utilizing an image in the capsule 1 to improve operability of the capsule generator.

For example, when the data opening button 141 is selected, the data opening variable setting window is displayed. When the data acquiring button 142 is selected, the data acquiring variable setting window is displayed. When the main method button 143 is selected, the program code for main method 13 in the source file is displayed in the source edition area 106.

[2.3.2 Capsule Analyzer and Capsule Scope]

The capsule analyzer is a tool to realize real-time debugging by displaying contents of a capsule 1 and monitoring a variable status through ACM 14. FIG. 7 shows one example of an analyzer screen 180.

When the capsule analyzer is activated, the analyzer screen 180 as shown in FIG. 7 is displayed in the display section 24.

The analyzer screen 180 is provided with a menu bar 180, a plurality of capsule selecting buttons 182, a capsule information display area 183, and a plurality of graph selecting radio button 184.

Further, when the capsule analyzer is activated, ACC 3 stats and transfers a registered capsule name to the capsule analyzer.

Then in the capsule selecting buttons 182, names of capsules 1 of the computer program P stored in the microcontroller M of the target board B is displayed.

The desired capsule 1 can be selected by selecting any one of the capsule selecting buttons 182 from the capsule analyzer. Then the identification number as information of the selected capsule 1 is transferred from ACC 3 to the capsule analyzer.

The ACC 3 calls ACM 14 of the appropriated capsule 1 from the capsule 1 acquired with the identification number. When ACM 14 is selected, the variation name and the comment are displayed in the capsule information display area 183 of the capsule analyzer to create an environment for easy debugging.

The information relate to variables (characters of variable name and comment, etc.) held by ACM 14 itself is a great characteristics of the development system S.

The capsule analyzer and the ACM 14 exchange information at regular time intervals to update the variable values displayed in the capsule information display area 183 to the latest information. Thereby variable values can be real-time displayed.

Thus, the capsule analyzer makes the control section 21 of the development terminal T function as a status providing means for sequentially displaying statuses of arithmetic processing provided by the target board B at predetermined period.

The graph selecting radio button 184 is a button for selecting variables to graph-display data contents in the capsule scope.

The capsule scope is a visual tool capable of confirming variables varying with graph every time the capsule 1 is called. Every time the capsule 1 is called, variables are temporarily stored in interior memory with AVM 14 and transferred to the capsule analyzer. The data transferred to the capsule analyzer are graph-displayed by the capsule scope.

FIG. 8 is a diagram showing one example of a scope window 190.

Arbitrary button are selected respectively with regard to CH1, CH2, and CH3 from graph selection radio buttons 184 on the screen of the capsule analyzer to select three variable values to be graph-displayed. When a capsule scope sub menu is selected form the tool menu of the menu bar 181, the scope window 190 as in FIG. 8(a) is displayed.

In the scope window 190, selected variables (3 variables in this case) are displayed in the graph display area 191, wherein the horizontal axis represents content call frequency (numbers of calls to ACM 14) and the vertical axis represents variables at time of each call).

Although respective variables are separately graph-displayed in FIG. 8(a), a plurality of graphs may be synthesized and displayed as in FIG. 8(b).

Respective programs of the capsule generator, the capsule analyzer, and the capsule scope may be downloaded from a server through network or may be recorded in a recording medium such as CD-ROM and read through the drive.

[3. Method for Developing Computer Program P]

Next, a method for developing a computer program P will be outlined. FIG. 9 is a diagram showing one example of development using a target board B in this embodiment.

As shown in FIG. 9, a skeleton capsule 10 (a header file/source file of skeleton capsule 10) is first read by a capsule generator. When a capsule name is set to create a new capsule, a header file/source file of the capsule 10 is newly generated.

Next, variables (open data variable, variable taking over open data in the acquiring method 12, variable used in the capsule, etc.) are registered in the capsule generator. Therefore, program codes for respective variables are generated in the source file of the capsule 1. At this time, a program code for transferring variables is also generated in ACM 14.

Further, the main method and the new method are selected and write and add the target program code in the source file of the capsule 1.

When an embedded command of the capsule generator is selected, embedment into TSU or OS can be conducted.

Generally, a capsule 1 is subsequently registered and compiled by the project menu of the compiler to generate a computer program.

A execution file (computer program P) generated in the compiler is written in a target board B using a writing tool. Therefore, the target board B can be operated.

The development terminal T and the target board B are connected through the serial communication cable K. When the capsule analyzer and the computer program P are both activated, the capsule selecting button and variable name of the appropriate capsule are displayed on the screen of the capsule analyzer. Then debugging operation can be started.

Next, one example of development of the computer program P by simulation. FIG. 10 is a diagram showing one example of the general configuration of developing method using simulation in the embodiment of the present invention.

The simulation is a method for making a computer program P to act as if it activated on the target board B by creating a program to simulate virtual peripheral devices with the conventional compiler in stead of actually installing the microcontroller M and the computer program P.

Thus, a sequential flow of operations from generation of the capsule 1 to verification are simulated with the development terminal alone as a simulation, so that operations of the capsule 1 can be confirmed with the development terminal T in the state that the target is not completed or there is no target.

A simulator is created as an execution file for the development terminal T with the conventional compiler. The execution file generated as the simulator is configured so as to be connectable with the capsule analyzer and the communication protocol such as TCP/IP (Transmission Control Protocol/Internet Protocol).

With regard to the computer program P and the capsule analyzer, the capsule analyzer may be embedded in the computer program P to form an integral configuration instead of a separate configuration. In this case, the arithmetic processing status is transferred from the computer program P to the capsule analyzer and can be directly displayed without displaying in the capsule analyzer and with omission of transfer.

As shown in FIG. 10, generation of new capsule by reading skeleton capsule 10, registration of variables, addition of program codes and embedment of TSU, etc. are same as mentioned above.

Subsequently, when the capsule 1 is registered by the project menu of the compiler and compiled for simulation, the simulator execution file as the computer program P is generated.

When the capsule analyzer and the simulator execution file are activated, the capsule selection button and the variable name of the appropriate capsule 1 are displayed on the screen of the capsule analyzer. Then debugging operation starts.

[4. Operation of Development System S]

[4.1 During Generating Computer Program P]

Next, the development system S having the above mentioned structure will be described. First, operation at the time of mainly generating program codes for the computer program P in the capsule generator will be described.

[4.1.1 generating a new capsule 1]

First, the operation at the time of reading the skeleton capsule 10 and generating a new capsule 1. FIG. 11 is a diagram explaining operation procedures in a new capsule creating box 102. FIG. 12 is a diagram showing one example of a header file (a) and a source file (b) of the skeleton capsule.

The capsule generator is executed by the control section 21 of the development terminal T, thereby a main screen 100 as shown in FIG. 5 is displayed on the display section 24.

As shown in FIG. 11, users set class name of capsule 1 against the class name input area 111 of the new capsule creating box 102 (e.g. change from initial class name “SkelCapsule” to “User Capsule”) select a replacing button 112 by a mouse and the like, and then the control section 21 reads a header file (FIG. 12(a)) and a source file (FIG. 12(b)) stored in the store section to be deployed in RAM.

In the example of the header file shown in FIG. 12(a), program codes for class definition of the skeleton capsule is described and class declaration is made with “_SkelCapsule”, and the constructor (_SkelCapsule), the main method 13 (SkelCapsule) and the ACM 14 (Capsule_ACM) are declared publicly. Then the data acquiring method 12 (GetMessage_P) is declared privately.

In the example of the source file shown in FIG. 12(b), a frame of the main method 13, a program code for calling the main method 13, and comment “write a program of the main method from here” are described, and with regard to the data acquiring method 12 and the ACM, only frames are described.

The control 21 changes the class name of the class definition in the header file deployed in RAM (e.g.

UserCapsule), and also changes the function name of the main method (e.g. UserCapsule).

The control section 21 generates a header file and a source file for a new capsule and then changes the function name of the main method in a source file deployed in RAM (e.g. UserCapsule).

The control section 21 stores the source file and the header file respectively thus generated in the store section 22.

Next, the control section 21 reads the source file stored in ACC 3, adds a program code for calling ACM 14 of the new capsule to the source file, and stores the source file in the store section 22.

Then the control section 21 displays the header file of the new capsule in the header display area 105 of the main screen 100 and the main method portion of the source file of the new capsule in the source edition area 106.

Users can confirm the contents of the header file and the source file of new capsule, input the program code with keyboard so that users can describe program below the comment “write a program of a main method from here” in the main method 13 of the source file.

Users select the storage sub menu from the file menu of the menu bar in the main screen 100, thereby the control 21 store the contents of the capsule 1 (the header file and the source file added with program codes) in the storage section 22.

[4.1.2 Addition of Open Variables]

Next, operation of adding open variables will be described. FIG. 13 is a diagram showing one example of data opening variables setting window 120. Then FIG. 14 is one example of program codes for the generated ACM 14.

When users select a Data opening button of the variable setting box 103 on the main screen 100, the control section 21 of the development terminal T displays the data opening variable setting window 120 as shown in FIG. 13 on the display section.

The data opening variable setting window is a window to set in the capsule 1 definition information of open data capable of acquiring outside to generate program codes for opening data. The window includes a variable type selection area 121, a variable name input area 122, an initial value input area 123, a comment input area 124, respective check boxes 125 for ACM generating option, and a code generating button 126.

Users set variable types (e.g. int, short), variable names (e.g. Data1_i).initial values(e.g. 0) and comments (arbitral characters) as definition information in respective areas and select ACM generating option according to necessity.

Thereafter, users select the code generating button 126, the control section 21 adds a program code (e.g. int Put_Data1

for defining open variables which are variables of open data with the variable name (e.g. Put_Data1_i) added with Pu before the variable name set in the menu, in the public section in the header file of the capsule l which is currently being edited), and further, comments set in the menu is added after program code for the variable definition.

“Put” added before a variable indicates the variable is externally open.

Next the control section 21 adds to the constructor section of the source file a program code for assigning contents of initial values set in the menu into the open variable (e.g. Put_Data1_i=0).

The control section 21 adds in ACM 1 of the source file a program code for transferring contents of open variables outside.

Particularly, the control section 21 adds to a variable basic information displaying method a program code for setting serial numbers, comments, variable names as contents transferred to the capsule analyzer (a portion enclosed with dotted line in FIG. 14(a)).

The control section 21 adds to a variable value list displaying method a program code for setting a variable value as contents transferred to the capsule analyzer (a portion enclosed with doted line in FIG. 14(b)).

Further, the control 21 adds in the graph displaying method a program code for setting a variable value in arrangement for storing contents en bloc-transferred to the capsule analyzer en bloc, as shown in FIG. 14(c)).

In the case of the capsule analyzer integrally embedded in the computer program P, a program code for setting serial number, comments, variable name, and variable value are added to the displaying arrangement as shown in FIG. 14(d).

[4.1.3 Generation of program code for acquiring data]

Next, operation of generating a program code for acquiring data will be described.

FIG. 15(a)is a diagram showing one example of a data acquiring variable setting window 130 and FIG. 15(b) is a modification.

When users select an acquiring button of the variable setting box 103 of the main screen 100, the control section 21 of the development terminal T displays the data acquiring variable setting window 130 as shown in FIG. 15(a).

The data acquiring variable setting window 130 is a window to set definition information of a variable taking over open data and designation information designating open data defined in the other capsule 1 and generate a data acquiring program code. As same with the data opening variable setting window 120, the window 130 includes a variable type area 131, a variable name input area 132, an initial value input area 133, a comment input area 134, respective check boxes 135 for ACM generation option, and a code generating button 136.

Users set variable type, variable name (set as “Put.” is deleted from the variable name, for example ,“Data1_i”, etc.), initial value, and comments in each area as definition information of takeover variable taking over open data, and select ACM generation option according to necessity.

Then, when users select the generating button 136, the control section 21 adds a program code for defining a takeover variable with a variable name (e.g. int. Get_Data1_I, etc.) added with “Get_” before the variable name set in the menu to the private section of the header file in capsule 1 under edition. Further, the control section 21 adds comments set in the menu after-the program code for defining the variable.

“Get_” added before the variable indicates the variable takes over the variable acquired from the exterior capsule 1.

The control section 21 adds in the source file constructor section a program code for assigning the initial contents set in the menu to the takeover variable (e.g. Get Data1_i=0, etc.).

The control section 21 retrieves the header file defined with open variable of the variable name (e.g. Put_Data1_i) added with “Put” before the variable set in the menu, and acquires the capsule name defined in the header file.

Thus the variable name set in the menu is a part of definition information for defining the takeover variable and also designation information in terms that an open variable defined in the other capsule 1 is designated.

Next, the control section 21 adds a program code for assigning the open variable to the takeover variable (e.g. Get Data1_I, etc.) in the data acquiring method 12 of the source file.

In the case that the control section 21 adds the program code for transferring contents of the takeover variable after the data acquisition in ACM of the source file, specific processing contents are same as in the case the open variable is added.

With regard to the data acquiring variable setting window 15, it may be configured as in FIG. 15(b).

In this case, the variable type selection area 131, the variable name input area 132, the comment input area 124, and various check boxes 135 are same as in FIG. 15 (a), but an open variable capsule selection area 137 and a variable selection area 138 are provided instead of the variable name input area 132, and an open variable already defined in the other capsule 1 is directly designated by setting the capsule name and the variable name as designation information.

In use of this configuration of the data acquisition variable setting window 130, processing for detecting file name from the header file is not required.

[4.1.4 Addition of Internal Variable]

Next, operation of adding an internal variable will be explained.

FIG. 16 is a diagram showing an internal variable setting window 140.

When users select a variable adding button of the variable setting box 103 in the main screen 100, the control section 21 of the development terminal T displays the internal variable setting window 140 as shown in FIG. 16.

The internal variable setting window 140 is a window to set definition information of the internal variable used only inside the, capsule 1 and generate a program for internal variables, and it is configured substantially same as the data opening variable setting window 120.

When users set definition information in the displayed variable name input area of the internal variable setting window 140 and select the code generating button 146, the control section 21 adds in the private section of the header file in the capsule 1 under edition a program code for defining internal variables with the variable name set in the menu (e.g. short DelayTime_s) and adds comments set in the menu after the program code defining variables.

The control section 21 next adds a program code for assigning contents of the initial value set in the menu to the constructer section of the source file (e.g. DelayTime_s=0;).

In the case that the control section 21 adds the program code for transferring the contents of the internal variable to outside, specific processing contents are same as in the case the open variable is added.

[4.1.5 Addition of New Method]

Next, operation of adding a new method will be described.

FIG. 17 is a diagram showing one example of a method function defining window 150.

When users select the new method adding box 104 of the main screen 100, the control section 21 of the development terminal D displays a method function definition menu 150 as shown in FIG. 17 on the display section 24.

The method function definition menu 150 is a window to newly add the method called directly or indirectly from the main method according to function call.

The method function definition menu 153 includes a return value type selection area 151, a method name input area 152, an argument variable type selection area 153, an argument variable name input area 154, a comment input area 155, and a code generating button 156.

When users set a return value type, a method name, an argument variable type, an argument variable name, and a comment, and finally select the code generating button 156, the control section 21 adds a program defining function of the method name set in the menu (e.g. “void TempConv(int):”, etc.) in the private section in the class definition of the header file in the capsule 1 under edition, and add the comment set in the menu behind the program code defining functions.

The control section 21 adds a program code of the new method function in the source file (e.g. void TempConv(int TemData_j.{}).

Next, the control section 21 displays the program code of the new method function in a source edition area 106.

Users input the program code with a keyboard in the source edition area 106 to add and edit the program code for the new method.

The main processing section related to the present invention includes a method directly or indirectly called from the main method as well as the main method (but the data acquiring method is excluded).

[4.1.6 Embedment to TSU 2]

Next, an operation of embedding a capsule 1 in TSU 2 will be described. FIG. 18 is a diagram showing one example of an embedment setting window 160 and FIG. 19 is a diagram showing one example of a source file of TSU 2.

Users select a menu for embedding TSU in the menu bar 101, the control section 21 of the development terminal displays in the display section a TSU embedment setting window 160 as shown in FIG. 18.

The TSU embedment setting window 160 is a window to generate the program code of TSU 2 for executing a capsule 1 under edition.

In the TSU embedment setting window 160 includes a variable value list display program code display area 161, a variable basic information display program code display area 162, a button display program code display area 163, a program execution display area 164, open button 165, a contents selection area 166, a task number selection area 167, a write button 168.

When users select the open button 165, the control section 21 reads out a source file of ACC 3 from the storage section 22 and displays, on the program code displaying areas 161 to 163, program codes for a method calling a method for displaying an ACC 3 variable value list, a method calling a method for displaying a variable basic information, and a button display method. The control section 21 reads out the source file of TSU 2 TSU 2 from the storage section 22, and display the program code for TSU 2 on the program code display area 164.

There are for example four types of contents displayed on the content selection area 166 and respective contents show a period of TSU 2 calling, 100.second, 1 m second, 10 m second, and 100 m second.

Users select the desired content (period) in the content selection area 166 to appropriately select a task number (time slot value).

When users select a write button 168, the control section 21 add program codes on the method for calling out the ACC 3 variable value list display method, the method for calling out the variable basic information method, the button display method and the TSU 2.

Specifically, the control section 21 adds the program code for calling out a variable value list display method of the capsule 1 under edition, the program code for calling variable display method of the capsule 1 under edition, the program code for setting capsule name of the capsule 1 under edition as a button display are respectively added on source file of ACC 3 (a potion enclosed with dotted lines of program code display areas 161 to 163).

Further, the control section 21 in the source file of TSU 2 adds the program code (a portion enclosed with dotted line) in the program code display area 164 for calling out the capsule 1 under edition in the capsule calling method corresponding to the set contents and the task number (time slot value).

Next, the control section 21 stores the source file of the method added with the program code.

In an example of TSU 2 shown in FIG. 19, the header file of each capsule is read, the program code for generating each capsule is described and the constructor of TSU 2 is also described.

Like a method for calling out a capsule 1 of the content 0, a method for calling out a capsule 1 corresponding to the task 1 of content 1, and a method for calling out a capsule 1 corresponding to the task 1 of the content 1, methods calling out capsule 1 to the task 9 of content 3 are described. Here all capsules 1 of the content 0 are called out and described in the order of call, ascendant order of the task numbers set in the TSU embedment setting window 160.

[4.1.7. Display of Organizing Condition]

FIG. 20 is a diagram showing one example of organizing the capsule 1 and the capsule generator has a function to visually display an entire structure of connection between capsules 1 with each other by selecting a button for displaying the structure. In this case, twenty pieces of capsules 1 are not regularly displayed not as in FIG. 20, but only the number of capsules 1 included in the project are displayed. Then an observer capsule holding only connection with each capsule 1 exists as data.

The capsule 1 added in the project file is displayed in an array state and connection between capsules of the project (the open data of the capsule 1 is acquired by the other capsule in the data acquiring method 12) is linked with line to display organizing condition.

Specifically, after the control section 21 acquires the open variable by retrieving the program code for defining the open variable from head files of all capsules, the control section retrieves connection between capsules by retrieving the program code assigning the open variable to the takeover variable to display, to result on the display section 24.

[4.2 During Debugging of Computer Program]

Next, an operation in which the computer program executed with the microcontroller M of the target board B is debugged using the capsule analyzer and capsule scope will be described. FIG. 12 is a diagram sowing one example of microcontroller M processing during debugging. FIG. 22 is a flowchart showing one example of process of the microcontroller M and the development terminal during debugging.

When a power switch, not shown, of the target board B is pressed to activate the target board B, the microcontroller M executes TSU 2 of the program P recorded in ROM.

In TSU 2, the microcontroller M generates all capsules 1 to initialize respective variables of all capsules 1 (Step S102).

The microcontroller M initializes time slot values of content 1, content 2 and content 3 (hereinafter referred to as TS2, TS2, TS3 respectively) to 0 (Step S102).

Next, the microcontroller M executes, in order, the main methods 13 of capsules 1 set in the content 0 (100 sec.) in the TSU embedded (Step S103).

Here, with the main method 13 executed by the microcontroller M, the data acquiring method 12 is called out from the main method 13 to acquire the open data, this acquired data is subject to the preset arithmetic processing in response to a function of each capsule 1 in the method called out from the main method and the appropriate method, a part of the results of which is set in the data open section as open data of the capsule 1.

The microcontroller M executes ACC 3 (Step S104), but an operation in ACC 3 is described later.

Next, the microcontroller M executes, in order, the main method 13 of the capsule 1 corresponding to the time slot value set in TS1 from the capsule 1 of the content 1 (Step S105).

Then, the microcontroller M judges whether or not the number of TS 1 is nine or more (Step S106), adds one to Ts 1 (Step S107) in the case of less than 9 (Step S106: NO), executes the capsule 1 of the content 0, executes ACC 3; and executes the capsule 1 of the content 1 corresponding to the next time slot value (Steps S103 to S105).

With regard to judgment in Step S 106, the microcontroller M sets 0 to TS 1 (Step S108) in the case of TS 1 of nine or more (Step S106: YES).

Next, with regard to TS 2 as well, the microcontroller M executes the capsule 1 corresponding to the time slot value set in TS 2 and judges whether or not the number of TS 2 is nine or more (Steps S109, S110), adds 1 to TS 2 (Step S111) in the case of TS2 of less than 9 (Step 110: NO), and then proceeds to Step S 103.

In the case that TS 2 is nine or more (Step S110: YES), the microcontroller M sets 0 to the TS 2 (Step S112), and performs the similar processing to the content 3 (Steps S113 to S116).

Thus, execution is sequentially performed at the period preset every capsule 1 by the round robin method and ACC 3 is also executed at the predetermined period.

In the above description, the periods of calling capsule 1 is of four patterns but the number of patterns may be increased or decreased.

Further, ACC 3 is not executed during execution of the capsule 1 of content 0 but ACC 3 may be executed during execution of the capsule 1 of content 1, for example. In this case the number of calling ACC3 in the specific period is one tenth to reduce a load on CPU.

Here, in the development terminal T, when users activate the capsule analyzer with the operation section 25, the control section 211 displays an analyzer screen 180 on the display section 24 (Step S301) to send a connection request to the target board B as sown in FIG. 22 (Step S302).

Communication with the development terminal T is processed in ACC 3 (Step S104). Specifically, the microcontroller M judges whether or not communication with the development terminal is under connection (Step S201), proceeds to Step S 202 in the case of no connection (Step S201: NO), and proceeds Step S205 in the case of connection (Step S201: YES).

In Step S202, the microcontroller M judges whether or not the connection request from the development terminal T is received, completes the process of ACC 3 if not received (Step S202: NO), and sends capsule names and identification numbers, etc of all capsules 1 to the development terminal T (Step S203) if received (Step S202: YES).

The development terminal T receives the capsule names and identification numbers from the microcontroller M, and displays the capsule names in the capsule selecting button 182 (Step S303).

The development terminal T selects e.g. the capsule 1 first received as an initial set of the capsule 1 to be selected (Step S304), and sends the identification number to the microcontroller M (Step S305).

The microcontroller M judges whether or not the identification number is received from the development terminal T (Step S204), changes the capsule 1 currently selected to the received identification number corresponding to the capsule 1 (Step S205), if the identification number is received (Step S204: YES), calls out the variable basic information displaying method of ACM 14, sends variable numbers and comments of all data of the selected capsule 1 to the development terminal T (Step S206), and proceeds to Step S208.

Meanwhile, if the identification number is not received from the development terminal T (Step S204: No), the microcontroller M judges whether or not any one of the capsules 1 is currently selected (Step S207) and proceeds to Step S208 if the selected capsule 1 exists (Step S207: YES) or completes the process of ACC 3 if it is not selected (Step S207: MO).

The development terminal T receives a variable name and comment of the selected capsule 1 from the microcontroller M and displays them in the capsule information display area 183 (Step S306).

The microcontroller M calls out the variable value list displaying method of ACM 14 and sends the current variable values of all data to the development terminal T (Step S208) and completes the process of ACC3.

The development terminal T receives the variable value sent from the microcontroller M and displays in the capsule information display are 183 (Step S307).

Further, the development terminal T judges whether or not the capsule scope is activated by user's selection (Step S308), updates the graph displayed in the graph display area 191 with the received variable, and redisplays it (Step S309), if the capsule scope is activated (Step S308: YES).

Next, the development terminal T judges whether or not any one of the capsule selecting buttons 182 is selected (Step S310), acquires the variable name, comment, variable value of the selected capsule 1 and display them respectively (Steps S305 to S309), if the button is selected (Step S310: YES).

Meanwhile, if the capsule selecting button 182 is not selected (Step 310: No), the development terminal T judges whether or not the end menu is selected by users (Step S311), and sequentially displays the variable values sent from the microcontroller M (Steps S307 to S309) if the menu is not selected (Step S311: No) or completes the capsule analyzer if selected.

When a variable value is real-time displayed while CPU occupation rate of the microcontroller M is being reduced, the micro controller M calls out the graph display method of ACM 14 to store the current variable value in RAM. The graph display method is called five hundred times and variable values of the five hundred times are accumulated, the micro controller M sends these en bloc to the development terminal T.

Meanwhile, the development terminal T receives variable values sent en bloc from the microcontroller M, and updates the graph displayed in the graph display area 191 with these valuable values of five hundred times, and redisplays it.

### EMBODIMENTS

Next, described is the present embodiments which are applied to development systems of computer programs embedded in microcontrollers for controlling system interconnection inverters installed in fuel-cell cogeneration systems.

In cogeneration systems, fuel gas such as city gas is reformed by gas reformers into hydrogen to be supplied to fuel cells, and electric power is generated by reaction between hydrogen and oxygen in the fuel cell while heat due to the generation is utilized to supply hot water. Further, a device which boosts voltage and converts DC to AC in order to supply electric power generated in the fuel cells to systems (or commercial load) is the system interconnection inverter.

In the system interconnection inverter, electric power is supplied according to voltage changes of the system in order to prevent the system from adverse affect due to supply voltage. When abnormality occurs to the system or the system interconnection inverter, electric supply has to be stopped to protect the system.

Then, in a relay control program as a computer program related to the present embodiment, the microcontroller monitors output voltage from the system interconnection inverter to detect abnormality of the system interconnection inverter, and controls the system relay conducting on/off of electric power supply.

First, a configuration of a development system S1 related to the present embodiment is described. FIG. 23 is a block diagram showing one example of the general configuration of the development system S1 related to the present embodiment.

As shown in FIG. 23, the development system S1 generally includes a system interconnecting inverter I and a development Terminal T.

The system interconnection inverter I includes a converter 31, an inverter 32, an isolation amplifier 33, a level shifter 34, a driving circuit 35, a system relay 36 and a microcontroller M1.

The converter 31 boosts low direct voltage of about several tens of voltage supplied from a fuel cell 4 to direct voltage of, for example, 320V or more and supply it to the inverter 32.

The inverter 32 converts DC electric power supplied from the converter to DC electric power of 50 Hz or 60Hz, supplies this as output electric power to the system 5 through the system relay 36, and supplies to the isolation amplifier 33. An output voltage value from the inverter 32 is about 2000V (min. −280V to max. +280V) if normal condition.

The isolation amplifier 33 decreases the DC electric power supplied from the inverter 32 to, for example, one hundredth so as to be input in the microcontroller 1, which is supplied to the level shifter 34.

The level shifter 34 shifts the DC electric power supplied from the isolation amplifier 33, for example, +5V, which is supplied to the microcontroller M1.

The driving circuit 35 supplies driving electric current to the system relay 36 to switch-open/shut off based on control signals supplied from the microcontroller M1.

The system relay 36 switch-open/shut off based on the driving current supplied from the microcontroller M1 to supply or stop supply of the output power from the inverter 32 to the system 5.

The microcontroller M1 includes CPU 41, RAM 42 for temporarily storing data and others, a flash ROM 43 for storing various programs (e.g. relay control program) and others, an A/D converter 45 for converting analog signals supplied from outside to digital values, an I/O port 44 for CPU 41 to exchange data with periphery devices, a communication circuit 46 for controlling communication state with the development terminal T, and the microcontroller M1 is interconnected with these through system bus 47.

The microcontroller M1 reads and executes respective programs stored in the flash ROM 43 to integrally control the converter 31 and the inverter 32 while converting the output voltage of the inverter 32 supplied from the level shifter 34 to digital values with the A/D converter 45. Based on this information the microcontroller M1 performs arithmetic processing, and supplies control signals according to the result to the driving circuit 35 through the I/O port 44 to control the system relay 36.

Next, configuration and function of capsules of the relay control program P1 related to the present embodiment will be described. FIG. 24 is a diagram showing one example of capsule configuration of the relay control program P1 related to the present embodiment.

The relay control program P1 is a program to obtain effective values of the output voltage input from the A/D converter 45 and send to the driving circuit 35 control signals to stop power supply to the system 5 if the effective value is 240V or more.

The relay control program 1 includes a plurality of capsules 1, TSU 2, and Acc 3, and has a sensor capsule 1a, a filter capsule 1b, a frequency monitoring capsule 1c, a filter factor selecting capsule 1d, a full-wave rectifying capsule 1e, a smoothing capsule 1f, a voltage monitoring capsule 1g, and a relay controlling capsule 1h.

The sensor capsule 1a is a program to read output voltage level of the inverter 32.

Specifically, the output voltage level converted into the digital value by the A/D converter 45 is first acquired.

Since this output voltage level is converted about +2.2V to +7.8V by the isolation amplifier 33 and the level shifter 34, reverse conversion is conducted for easy handling in the later arithmetic processing (e.g. subtracting 5V and then multiplying 100 times to make voltage about −280V to +280V (in the case of normal system relay inverter)) and the output voltage is set in the open data section 11.

The filter capsule 1b is a program to remove high frequency noise from output voltage signals.

Specifically, for example, every time TSU 2 is called out, output voltage level or open data of the sensor capsule 1a is acquired and stored, constant pieces of output voltage levels previously acquired are respectively multiplied with a filter factor or open data of the filter factor selecting capsule 1d according to preset weighting, and the mean value is set in the data open section 11.

The frequency monitoring capsule 1c is a program to monitor frequency (50 Hz or 60 Hz) of output voltage and open this.

Specifically, the noise-removed output voltage level opened in the filter capsule 1b is acquired and compared with 0. Here, when the output voltage level is 0, time elapsed since the time when the previous output voltage level is calculated (calculated based on numbers and period of calls from TSU 2). Further, frequency is calculated on this elapsed time and set in the data open section 11.

The filter factor selecting capsule 1d determines filter factor for removing signals of noise according to the frequency of the output voltage signals.

Specifically the frequency or open data of the frequency monitoring capsule 1c is acquired, and the filter factor preset as constant number corresponding to this is set in the data open section 11.

The full-wave rectifier capsule 1e is a program to convert AD or the output voltage signal to DC.

Specifically, the output voltage level or open data of the filter capsule 1b is acquired and an absolute value of this output voltage level is set as rectified voltage level in the data open section 11.

The smoothing capsule 1f is a program to smooth the output voltage signal full-wave rectified and obtain a execution value of the output voltage

Specifically, rectified voltage level or the open data of the full-wave rectifying capsule 1c is acquired and stored at every call from TSU 2 while frequency or the open data of the frequency monitoring capsule 1c is acquired, and the number of calls from TSU 2 corresponding to period or inverse of this frequency and a mean value of the rectified voltage values past stored are set in the data open section 11 as an effective voltage level.

The voltage monitoring capsule 1g is a program to detect abnormality of output voltage.

Specifically, an effective voltage level or the open data of the smoothing capsule 1f is acquired and set in the data open section 11 as an alarm value, for example, 0 (meaning no abnormality), if the effective voltage level is less than 240V.

Meanwhile, if the effective voltage value is 240V or more, the voltage level is judged abnormal and the numbers of times when voltage levels continuously become 240V and more are counted. Then when the counted numbers reaches the numbers for e.g. one second, 1 (meaning presence of abnormality) is set in the data open section 11 as an alarm value.

The relay controlling capsule 1h is a program to send control signals for on/off switching the system relay 36 to the driving circuit 35 through the I/O port 44, when the effective value of the output voltage is abnormal.

Specifically, an alarm value or the open data of the voltage monitoring capsule 1g is acquired and data for sending control signals corresponding to this alarm value is output to the predetermined address in the I/O port 44.

Next, outline of the rely control program P1 related to the present embodiment will be described.

In order to create the capsule having the above mentioned function, a header file and a source file of respective capsules are generated by the new capsule creating box 102 of the capsule generator.

With regard to open data set in the data opening section 11, a program code for open data is added by the open variable setting window, and with regard to data acquired by the data acquiring method 12, a program code for data acquiring by the data acquiring variable setting window. In this case, comment names, variable names, data types and initial values are appropriately set.

Next, a program code for main method is added by inputting the program code to a source edition area based on function specification of each capsule and the program code of each capsule is created. In this case, inner variables and new methods are appropriately added.

The header file and the source file of each capsule are stored and call period is respectively set 100.second when it is embedded.

Finally, after each capsule is added to the project and compiled to generate the relay control program P1 capable of executing the micro controller M1.

Next, operation of the system interconnection inverter 1 will be described.

After the converter 31 increases electric power of low voltage, supplied from fuel cell 4 is increased by the converter 31, converted with the inverter 32 to AC having a frequency of 50 Hz or 60 Hz, and supplied to the isolation amplifier 33 and the system relay 36 as output electric power.

When the isolation amplifier 33 decreases the output voltage supplied to one hundredth and supplies to the level shifter 34, the level shifter 34 level-shifts it +5V and supply to the A/D converter 45 in the microcontroller M1.

The microcontroller M executes the relay control program P1 to sequentially call out capsules 1a to 1h from TSU 2 for execution.

Specifically, the microcontroller M1 acquires and converts the output voltage level converted into digital value by A/D converter 45, and removes the filter capsule 1b of high-frequency noise.

Current frequency is acquired based on the voltage level removed of noise in the frequency monitoring capsule 1c, and the filter factor is selected based on this frequency in the filter factor selecting capsule 1d to feedback in arithmetic processing in the capsule 1b of the next period.

Next, the microcontroller M1 converts the voltage level removed of noise into the absolute value by full-wave rectifying capsule 1e to acquire the voltage effective value by the smoothing capsule 1f.

The microcontroller M1 judges whether or not the voltage effective value is abnormal by the voltage monitoring capsule 1g to set alarm value, and based on this alarm value, control signals are supplied to the driving circuit 35 by the relay controlling capsule 1g through the I/O port 44.

The microcontroller M1 repeatedly executes the above mentioned arithmetic processing at the period of 100.second from TSU2 to execute respective capsules in parallel.

The driving circuit 35 supplies driving current to the system relay 36 according to the control signals supplied from the microcontroller M1 and switches on/off based on this driving current.

Here, when effective value of the output voltage of the inverter 32 is less than 240V, the system relay 36 is switched on to supply electric power to the system 5.

Meanwhile, when effective value of the output voltage of the inverter 32 continues for one second or more to reach 240V or more, the system relay 36 is switched off to stop current supply to the system 5.

Thus, in the present embodiment, a plurality of capsules 1 having very simple function are integrated, thereby control function of the system relay of the system interconnection inverter can be achieved relatively easily.

Further, since each capsule 1 designed based on the rule in which data is opened by the data open section 11 and data is acquired by the data acquiring method 12 is independent of the other capsule processing, basically the existing capsule 1 is not needed to change but capsule 1 necessary for additional function is newly added.

Next, a result of monitoring execution of the relay control program P1 by the capsule analyzer of the development terminal T and displaying graphs by the capsule scope will be described FIG. 25 is a diagram showing one example of results of graph displaying open data of each capsule. (a) represents output voltage level, (b) represents output voltage level removed of noise, (c) represent rectifying voltage level, (d) represents effective voltage level and (e) represents alarm value.

As shown in FIG. 25, waveform of output voltage, waveform removed this of noise, waveform of full-wave rectifying, and waveform of smoothing are real-time displayed by the capsule scope, thereby arithmetic processing status in the main method 13 of each current capsule 1 can be grasped at a glance.

Here, when there is a problems, for example, in filter capsule 1b and the open data or output voltage level is 0, data contents set from the full-wave rectifying capsule 1e to the relay control capsule 1f is also of abnormal value, and electric power is constantly supplied to the system 5 regardless of normal/abnormal of the output voltage of the inverter 32.

If debugging is performed using ICE and the like, a break point is set with predetermined program code of the main method 13 in the filter capsule 1b, execution of the relay control program P1 is stopped by monitoring registration to display the output voltage level removed of noise. Even if displayed value is 0, it is impossible to judge whether or not the relay control program P1 is normal only based on this. Granted that it is possible to judge it abnormal, it is impossible to judge whether it is caused by the filter capsule 1b or the sensor capsule 1a.

Even if the relay control program P1 is re-executed to seek the location of the cause, there is a possibility of not seeking the cause when the output voltage level set in the filter capsule 1b returns to the normal level because condition of the system interconnection inverter I is changed during suspension of the program P1.

Further, when abnormality occurs to the system interconnection inverter I during suspension of the relay control program P1 and output voltage of the inverter 32 becomes abnormal, abnormal voltage power is supplied to the system 5 to cause adverse effect to the system 5.

On the other hand, in the present embodiment, it is found that sinusoidal waveform of the output voltage which should have been subjected to noise removal is dropped off as in FIG. 25(b), while output voltage level or open data of the sensor capsule 1a maintain a waveform showing normal condition as in FIG. 25(a).

Thus it becomes possible to accurately judge there is a problem in the filter capsule 1b.

As described above, according to the present embodiment, each capsule 1 has the same structure to make the microcontroller M function as a data open section 11 or open data area means to be set with open data capable of acquiring from the other capsule 1, an open data acquiring means in the data acquiring method 12 for acquiring the open data set in the data open section 11 in other capsules 1, a main processing means for executing arithmetic processing preset for the open data acquired in the data acquiring method 12 and for setting at least a part of the results obtained by the arithmetic processing set as open data in the data open section 11, and a status provision means for providing ACM 14 with arithmetic processing status in the main method 13 at predetermined period.

Accordingly, the capsule 1 has rules of opening data by the data open section 11 and acquiring data by the data acquiring method 12, and arithmetic processing is executed in the main method based on these rules, thereby security of data is ensured.

Each capsule 1 acquires open by data itself to execute arithmetic processing without depending on processing of the other capsule 1 and has the same simplified structure for opening at least a part of the results, thereby occurrence of design mistakes decreases and reliability as the computer program P is improved.

Further, each capsule 1 has ACM 14 which can real-time monitors status of arithmetic processing in the main method of the microcontroller M from outside without stopping execution of the computer program P by sequentially displaying statuses of arithmetic processing real-time sent by the development terminal executing the capsule analyzer, thereby debugging of the computer program P in the embedded system S become easy.

Further, in the capsule analyzer, users select desired capsule 1, the development terminal T sends the identification number of the capsule 1 to the microcontroller M, the microcontroller M receives the identification information in ACC 3 of the computer program P to execute processing of ACCM 14 of the capsule 1 indicated by the identification number and to send the arithmetic processing status in the main method 13 to the development terminal T, and the development terminal T receives this arithmetic processing status and sequentially displays on the display section 24, thereby capable of debugging specified to desired capsule 1.

Thus, for software reliability and quality improvement, the method for detecting while activating the capsule is provided. ACM 14 is provided inside the capsule 1, and ACM 14 communicates with the capsule analyzer outside and real-time sends the variable status of the capsule 1 to the capsule analyzer. Developers can confirm contents displayed in the capsule analyzer, track and correct defective portions.

Further, the development terminal T chronologically displays status of the arithmetic processing in the main method 13 and graph display is visually understandable, thereby whether or not the capsule 1 has a problem can be judged at a glance.

Furthermore, the computer program P has TSU 2 which sequentially executes arithmetic process in the main method 13 of respective capsules at preset period every capsule 1, the arithmetic processes in the main method 13 of each capsule 1 are executed in parallel according to more simplified execution rules, for example executed repeatedly at 1. sec. period, thereby design, verification and others of the computer program P become more easy.

According to the present embodiment, the development terminal T generates definition codes for generating program codes to define open data based on definition information such as variable type, variable name, initial value, comment of the open data input by users with the capsule generator, generates a program code for the data acquiring method 12 based on designation information such as variable names input by users, generates a program code for the main method 13 based on the program code input by users, and generates a program code for AVM 14 for open variable, take-over variable and internal variable based on the definition information, designation information, etc.

Therefore, program codes for the capsule 1 having the data open section 11, the data acquiring method 12, and the main method 13, can be easily created, and program coded for ACM 14 is automatically generated, thereby labor of manually creating program code for debugging every capsule program can be remarkably saved because.

Although the computer program P in the present embodiment is developed in C++ language, the program may be developed in, for example, nonobject-oriented language as long as each variable and method can be encapsulated same as mentioned above.

Further, although the computer program P is applied for embedded type program used for the embedded system in the present embodiment, it may be applied to the other system.

Thus the present invention is not limited to foregoing embodiments. The foregoing embodiments are just exemplification and any one having configuration and effect substantially same with the technology concept described in the claims of the present invention should be included in scope of the skill of the present invention.

Further, all disclosures of Japanese Patent Application (No.2004-332430) including specification, claims, drawings, and abstract filed on Oct. 19, 2004 is incorporated here in terms of reference.

1-18. (canceled)

19. A program generation processing program executed by a second computer included in a program generating device for generating a computer program which is formed by an assembly of a plurality of capsule programs, the plurality of capsule programs having a same structure, and being executed by a first computer, the capsule programs respectively comprising:
an open data portion to cause the first computer function as an open data acquiring means for setting up the open data which are acquirable from another capsule program than the capsule program of this open data portion;
an open data acquiring portion to cause the first computer function as an open data acquiring means for acquiring the open data which are set up in the open data area means in the another capsule program; and
a main processing portion to cause the first computer function as a main processing means for executing a preset arithmetic processing to the open data acquired with the open data acquiring means and setting up the open data area means with at least a part of results, which is obtained by the arithmetic processing as the open data, wherein
the program generation processing program causes the second computer to function as a capsule code generating means, and
the capsule code generating means comprising:
a definition code generating means for generating program codes for defining the open data based on the definition information which is inputted by a user and is indicative of a content of definition of the open data set up in the open data area means;
an acquisition code generating means for generating program codes of the open data acquiring portion which acquires the open data selected by a user through the input means, out of the open data which are defined by the capsule program; and
a main processing code generating means for generating program codes of the main processing portion on the basis of the program code inputted by a user through the input means.

20. The program generation processing program according to claim 19, wherein
the computer program further comprises an execution control program for controlling execution of the capsule programs with the first computer,
an execution unit in executing the plurality of capsule programs are set up with respect to a lapse of predetermined times within a repeated execution cycle,
each of the capsule programs is respectively allocated to at least one of the plurality of execution units on the basis of the repeated execution cycles respectively set up with respect to the capsule programs,
the execution control program executes the main processing portion of the capsule program, allocated to the execution unit thus corresponding, at each lapse of the predetermined time and causes the first computer function as the execution control means for repeatedly executing the capsule programs, and
the program generation processing program further causes the second computer function as an execution control code generating means for generating a program code of the execution control program based on the execution cycle information which is inputted by a user through an inputting means and is indicative of the execution cycle with respect to each of the capsule programs.

21. The program generation processing program according to claim 19, wherein
each of the capsule programs further comprising:
a status providing portion for causing the first computer function as a status providing means for providing status of the arithmetic processing every predetermined period with the main processing means, and
a status provision code generating means for generating a program code of the status providing portion for providing information related to the open data based on the definition information, which is used for generating the program code, defining the open data.

22. The program generation processing program according to claim 21, wherein
the computer program further comprising
a status provision selection executing program to cause the first computer function as a status provision selection executing means which acquires selection information indicative of selection of at least one of the capsule programs and executes processing in the status providing portion of the capsule program thus selected, wherein
the execution control means executes the status provision selection executing program at each of the predetermined cycle, and
the program generation processing program further causes the second computer function as a status provision selection executing code generating means for generating program code of the status provision selection executing program.

23. The program generation processing program according to claim 22, wherein
the status providing means comprises:
a status accumulating means for accumulating the statuses of the arithmetic processing of the main processing means, which is executed by the status provision selection executing means at every execution by the status provision selection executing means; and
a status en bloc providing means for providing the accumulated statuses en bloc.

24. The program generation processing program according to claim 21, wherein
the status provision code generating means further generates a program code of the status providing portion for providing information related to the open data thus selected.

25. A method for generating program codes in a program generating device for generating computer programs which are formed by an assembly of a plurality of capsule programs respectively having a same structure and executed by a computer, the computer program comprising:
an open data portion for causing the computer function as an open data area means where open data acquirable from another capsule program than the capsule program of this open data portion are set up;
an open data acquiring portion to cause the computer function as an open data acquiring means for acquiring the open data which are set up in the open data area means in the another capsule program; and
a main processing portion to cause the computer function as a main processing means for executing a preset arithmetic processing to the open data, acquired by the open data acquiring means and setting up the open data area means with at least a part of results acquired by the arithmetic processing as the open data,
the program code generating method in the program generating device for generating the computer program, formed by an assembly of the plurality of capsule programs having the structure thus formed, comprising:
a capsule code generating step of generating the program code with respect to each of the program codes;
the capsule code generating step comprising:
a definition code generating step of generating a program code for defining the open data based on definition information, which is input by a user through an input means and is indicative of definition content of the open data which are set up in the open data area means;
an acquisition code generating step of generating a program code of the open data acquiring means which acquires the open data selected by a user through the input means out of the open data thus defined by the another capsule program, and
a main process code generating step of generating a program code of the main processing portion which is inputted by the user through the input means.

26. A program generating device for executing the program generation processing program according to claim 19, wherein
the program generating device comprising the capsule code generating means.

27. A computer program which is generated with the program generation processing program according to claim 19, and formed by an assembly of a plurality of capsule programs respectively having a same structure, wherein
each of the capsule programs comprising:
the open data portion;
the open data acquiring portion; and
the main processing portion.

28. The program generation processing program according to claim 20, wherein
each of the capsule programs further comprising:
a status providing portion for causing the first computer function as a status providing means for providing status of the arithmetic processing every predetermined period with the main processing means, and
a status provision code generating means for generating a program code of the status providing portion for providing information related to the open data based on the definition information, which is used for generating the program code, defining the open data.

29. The program generation processing program according to claim 22, wherein
the status provision code generating means further generates a program code of the status providing portion for providing information related to the open data thus selected.

30. The program generation processing program according to claim 23, wherein
the status provision code generating means further generates a program code of the status providing portion for providing information related to the open data thus selected.
